(19) United States
(12) Patent Application Publication
(10) Pub. No.: US 2018/0354181 A1
(43) Pub. Date: Dec. 13, 2018

(54) EXTRUSION APPARATUS AND METHODS

(71) Applicant: University of Massachusetts, Boston, MA (US)

(72) Inventor: David O. Kazmer, Georgetown, MA (US)

(21) Appl. No.: 15/780,381

(22) PCT Filed: Dec. 2, 2016
(86) PCT No.: PCT/US2016/064527

§ 371 Date: May 31, 2018

Related U.S. Application Data
(60) Provisional application No. 62/263,381, filed on Dec. 4, 2015.
(60) Provisional application No. 62/365,550, filed on Jul. 22, 2016.

(51) Int. Cl. B29C 47/60; B29C 47/08; B29C 47/38; B29C 47/62; B29C 33/38

(52) U.S. Cl. CPC B29C 47/6087; B29C 47/0844; B29C 33/3835; B29C 47/622; B29C 47/627; B29C 47/385

(57) ABSTRACT

Extrusion apparatus and methods for use in the design and operation of extrusion screws having multiple channels. In response to rotation of an extrusion screw in an extrusion process, the multiple channels of the extrusion screw can control the temperature, pressure, and/or shear rate of feedstock material flowing through the respective channels. The multiple channels of the extrusion screw can be configured to control the temperature, the pressure, and/or the shear rate of the processed feedstock material by being modeled as one or more model objects having one or more predetermined geometries. The models of the respective channels can then be analyzed using computerized analytical and/or numerical techniques in order to obtain at least estimates of desired temperatures, pressures, and/or shear rates of the processed feedstock material, based at least on specified channel lengths, channel widths, and/or channel depths of the respective channel models.

### CROSS REFERENCE TO RELATED APPLICATIONS

This application claims benefit of PCT application No.: PCT/US2016/064527 filed Dec. 2, 2016 entitled EXTRUSION APPARATUS AND METHODS which claims the priority of U.S. Provisional Patent Application No. 62/365,550 filed Jul. 22, 2016 entitled EXTRUSION APPARATUS AND METHODS, and U.S. Provisional Patent Application No. 62/263,381 filed Dec. 4, 2015 entitled EXTRUSION SCREWS WITH MULTIPLE CHANNELS.

### TECHNICAL FIELD

The present application relates generally to screws for use in feeding, melting, pumping, extrusion, molding, and/or other manufacturing processes, and more specifically to apparatus and methods of configuring screws that allow control of temperatures, pressures, and/or shear rates of feedstock materials in extrusion and/or molding processes.

### BACKGROUND

Extrusion processes are known that employ extruders and extrusion screws in the compounding and polymerization of feedstock materials, as well as in the conversion of such feedstock materials into finished goods such as tubing, sheets, films, profiles, etc. Extrusion screws can also be used directly in processes including blow molding, injection molding, thermoforming, and other processes for the generation of plasticized melt. The feedstock materials can include thermoplastic and thermosetting polymers, and composites of such feedstock materials including different types and/or grades of polymers and/or various additives. A conventional extruder can include a rotatable extrusion screw disposed in a stationary extruder barrel. Such an extrusion screw typically includes at least a feed zone, a transition zone, and a metering zone, as well as a helical channel that can vary in pitch, width, and/or depth within the feed, transition, and/or metering zones of the extrusion screw. In a typical extrusion process, a feedstock material can be provided to the helical channel through an inlet port located in the feed zone of the extrusion screw, and subsequently processed as the rotating extrusion screw forces the feedstock material to flow through the helical channel to the transition zone and ultimately to an outlet in the metering zone of the extrusion screw.

Various sizes and/or configurations of conventional extrusion screws have been developed for use in processing different types of feedstock materials. Such conventional extrusion screws can have drawbacks, however, including, but not limited to, extended residence times of the feedstock materials being processed, fluctuations in flow rates and/or pressures of the processed feedstock materials, inconsistent temperatures of resulting extrudate materials, poor dispersion and/or uniformity of the resulting extrudate materials, and excessive energy consumption.

### SUMMARY

In accordance with the present application, extrusion apparatus and methods are disclosed for use in the design and operation of extrusion screws having multiple channels. In one aspect, an extrusion screw is provided that includes a plurality of channels disposed at varying locations along a solid cylinder of the extusion screw for processing feedstock material. The plurality of the channels can have distinct channel lengths, channel widths, and channel depths in order to achieve varying design objectives at different axial locations of the extrusion screw. Each of the plurality of channels can transition in channel depth and/or channel width along the length of the extrusion screw, and can have a size and/or shape proportioned relative to the expected size and/or shape of pieces of the feedstock material.

In response to rotations of the extrusion screw in an extrusion process, the multiple channels of the extrusion screw can control the temperature, pressure, and/or shear rate of the feedstock material flowing through the respective channels in a feed zone, a transition zone, and/or a metering zone of the extrusion screw. In one aspect, the multiple channels of the extrusion screw can be configured to control the temperature, the pressure, and/or the shear rate of the processed feedstock material by being composed as two or more channel geometries. The respective channel geometries can be analyzed using analytical and/or numerical techniques in order to obtain reasonable estimates of desired temperatures, pressures, and/or shear rates of the processed feedstock material, based on specified channel lengths, channel widths, and/or channel depths of the respective channel models.

The extrusion apparatus and methods disclosed herein can reduce issues of residence time, energy consumption, and/or temperature inconsistencies by specifying the relative channel dimensions in the feed zone, the transition zone, and/or the metering zone of an extrusion screw, thereby allowing the temperature, the pressure, and/or the shear rate of the processed feedstock material to be controlled as a function of the temperatures of the extrusion screw and/or an extruder barrel in which the extrusion screw is disposed, screw rotational speed or volumetric flow rate, and/or shear heating, taking into account the feedstock material's compressibility and/or viscosity behavior. In an extrusion process, most of the energy for heating and melting the feedstock material is generally produced by internal shear heating of the feedstock material. In order to increase the internal shear heating and promote more rapid melting of the feedstock material, channel depths can be reduced to compress the feedstock material in at least the transition zone of the extrusion screw. Further, in order to avoid excessive temperatures of the processed feedstock material due to the increased internal shear heating, channel depths can be increased to decompress the feedstock material in at least the metering zone of the extrusion screw.

Such selective compression and decompression of feedstock material by an extrusion screw in an extrusion process can allow the overall length of the extrusion screw to be reduced, thereby reducing the size, cost, and complexity of the extruder in which the extrusion screw is incorporated. Reducing the overall length of the extrusion screw can also reduce the residence time of feedstock material in channels of the extrusion screw, thereby reducing the likelihood of degradation of the properties of the resulting extrudate material. Moreover, such selective compression and decompression of the processed feedstock material can allow the temperatures, the pressures, and/or the shear rates of the feedstock material to be controlled, thereby reducing the likelihood of excessive temperatures and/or pressures in the extrusion process while avoiding the need for external active cooling of the extruder.

In one aspect, a channel in the feed zone of an extrusion screw can be divided into multiple channels for more uniformly processing each piece of the feedstock material, thereby providing improved dispersion and/or uniformity of the processed feedstock material. One or more of the multiple channels can then be further divided into multiple channels for metering the processed feedstock material with improved temperature consistency and/or reduced energy consumption. In this way, the extrusion screw can avoid a large solidified bed composed of many pieces of the feedstock material, which can lead to prolonged feedstock material residence times. The multiple channels of the extrusion screw provide a means for quickly and efficiently processing the feedstock material, while reducing fluctuations in flow rates and/or pressures of the processed feedstock material.

In a further aspect, an extrusion screw is provided that includes a feed zone where the feedstock material can enter a feed channel having a channel depth and/or a channel width greater than the expected size of each piece of the feedstock material, thereby allowing multiple pieces of the feedstock material to enter the feed channel with each rotation of the extrusion screw. The width and/or the depth of a downstream portion of the feed channel can then vary in size in order to admit the processed feedstock material into at least one transition channel of the extrusion screw. The width and/or the depth of the transition channel(s) can also vary in size in order to process each piece of the feedstock material. Such an extrusion screw can significantly reduce the time required to process the feedstock material. Each transition channel in a transition zone of the extrusion screw can have an outlet that connects to one or more inlets of metering channels in a metering zone of the extrusion screw. Providing at least two metering channels in the extrusion screw can help to maintain consistent temperatures and/or homogeneity of the processed feedstock material, as well as improve energy efficiency. The channel depth at the inlet of each metering channel need not be uniform across the respective metering channels, but can generally be less than the channel depth of the inlet of the transition channel to which the metering channel is connected.

In another aspect, an extrusion screw is provided that includes multiple feed channels in a feed zone of the extrusion screw, thereby allowing entry of the feedstock material at a desired volumetric feed rate using feed channels having reduced channel depths. The reduced channel depths of the feed channels can reduce the depth of a solidified bed of feedstock material in the respective feed channels, thereby facilitating the feeding of the feedstock material from the feed channels to the downstream transition and metering channels. The inlets of the multiple feed channels can be positioned at different longitudinal positions along the length of the extrusion screw in order to allow the feeding and processing of different types of feedstock materials, which can be subsequently processed in parallel and recombined for achieving various design objectives.

In still another aspect, the depths of channels included in an extrusion screw can be specified to promote uniform flow rates, pressures, and/or temperatures of the processed feedstock material across multiple outlets of downstream metering channels. The selection of each channel depth can be made with the assistance of computerized analysis and/or simulation techniques, based on the properties of the feedstock material and its governing physics. The extrusion screw can include multiple mixing sections of varying sizes downstream of the outlets of the metering channels in order to promote homogeneity in the melt of the feedstock material before the resulting extrudate material exits the extruder.

In an exemplary aspect, such an extrusion screw can include at least one feed channel in the feed zone, at least one transition channel in the transition zone, and at least two metering channels in the metering zone, thereby allowing one or more outlets of the transition channel(s) to connect to inlets of multiple metering channels. By including multiple metering channels in the extrusion screw, more consistent temperature and/or homogeneity of the feedstock material, as well as increased energy efficiency, can be achieved. The channel depth at the inlets of the multiple metering channels need not be uniform across the metering channels, but can generally be less than the channel depth of the inlet of the transition channel to which a respective metering channel is connected. Further, the channel depth and the channel width at the outlets of the multiple metering channels need not be uniform across the metering channels, but can be either less than the channel depth and the channel width at the inlets of the respective metering channels if compression of the processed feedstock material is desired, or more than the channel depth and the channel width at the inlets of the respective metering channels if decompression of the processed feedstock material is desired.

In a further exemplary aspect, compression and decompression of the processed feedstock material can be achieved by providing different diameters and/or different taper angles for the multiple metering channels in the metering zone. One or more of the multiple metering channels can have generally annular cross-sections, thereby allowing such decompression and cooling of the processed feedstock material to be achieved by having the included angle at a distal end of the extrusion screw (which can form the inner wall of a respective annular metering channel) be less than the included angle at an end cap of the extruder barrel (which can form the outer wall of the respective annular metering channel). Such decompression and cooling of the processed feedstock material can also be achieved by adjusting the annular thickness of the metering channel(s) through an axial displacement of the extrusion screw, which can be dynamically adjusted (such as by a linear actuator) as a function of the temperature and/or the pressure of the processed feedstock material. Likewise, certain settings of the extrusion process, such as the screw rotation speed, one or more temperature settings, etc., can be adjusted based on the temperature and/or the pressure of the processed feedstock material.

In yet another aspect, a screw for use in a manufacturing process can include a cylindrical body, and one or more helical channels formed in a surface of the cylindrical body. Each of the helical channels has a channel width and a channel depth, and can be configured to receive a feedstock material. In response to rotation of the cylindrical body, the helical channels can control one or more of a temperature, a pressure, and a shear rate of the feedstock material flowing through the respective helical channels based at least on the channel width or the channel depth of the respective helical channels. In an exemplary aspect, each of the helical channels can be configured to control the temperature, the pressure, and/or the shear rate of the feedstock material by being modeled as a model object with a predetermined geometry. The geometry can have one or more dimensions representing the channel width and/or the channel depth of the helical channel. The model object can be analyzed to obtain at least an estimate of the temperature, the pressure, or the shear rate of the feedstock material based at least on one or more of the dimensions of the geometry of the model object.

Other features, functions, and aspects of the present application will be evident from the Detailed Description that follows.

### BRIEF DESCRIPTION OF THE DRAWINGS

The accompanying drawings, which are incorporated in and constitute a part of this specification, illustrate one or more embodiments described herein, and, together with the Detailed Description, explain these embodiments. In the drawings:

FIGS. 1a-1d are diagrams of a first exemplary extrusion screw having one (1) feed channel and four (4) transition channels, in accordance with the present application;

FIGS. 2a-2d are diagrams of a second exemplary extrusion screw having one (1) feed channel, four (4) transition channels, and twelve (12) metering channels, in accordance with the present application;

FIGS. 3a-3d are diagrams of a third exemplary extrusion screw having two (2) feed channels, four (4) transition channels, and four (4) metering channels, the third exemplary extrusion screw being configured for use in single extrusion or co-extrusion processes, in accordance with the present application;

FIGS. 4a-4d are diagrams of a fourth exemplary extrusion screw having one (1) feed channel, three (3) transition channels, six (6) metering channels of varying channel depths, and two (2) mixing sections of varying sizes, in accordance with the present application;

FIGS. 5a-5d are diagrams of a fifth exemplary extrusion screw having two (2) feed channels, four (4) transition channels, four (4) metering channels, and an internal bore for use in coextrusion processes, in accordance with the present application;

FIG. 6 is a diagram of a first exemplary computer-aided design (CAD) model of a portion of an extrusion screw design, the first CAD model including a swept cut defined by sweeping a channel cross-section along a path of a variable pitch helix, in accordance with the present application;

FIG. 7 is a diagram of an exemplary extruder including the fourth exemplary extrusion screw of FIGS. 4a-4d, and further including illustrations of feedstock material being processed at varying locations within the exemplary extruder;

FIGS. 8a-8d are simulation flow diagrams illustrating a flow of feedstock material, at varying flow rates, through the respective channels of the first exemplary extrusion screw of FIG. 1;

FIG. 9a is a diagram of estimates of temperatures of processed feedstock material as a function of channel length, the feedstock material being processed by an exemplary extrusion screw having multiple metering channels with uniform depths;

FIG. 9b is a diagram of estimates of changes in pressure of the processed feedstock material as a function of channel length, the feedstock material being processed by the exemplary extrusion screw having multiple metering channels with uniform depths;

FIG. 10a is a diagram of estimates of temperatures of processed feedstock material as a function of channel length, the feedstock material being processed by an exemplary extrusion screw having multiple metering channels with varying depths;

FIG. 10b is a diagram of estimates of changes in pressure of the processed feedstock material as a function of channel length, the feedstock material being processed by the exemplary extrusion screw having multiple metering channels with varying depths;

FIG. 11 is a flow diagram of a first exemplary method of designing an extrusion screw, in accordance with the present application;

FIG. 12 is a diagram of estimates of specific volumes of processed feedstock material as a function of melt temperature at a plurality of processing pressures;

FIG. 13 is a diagram of estimates of apparent viscosities of processed feedstock material as a function of shear rate at a plurality of processing temperatures;

FIG. 14 is a flow diagram of a second exemplary method of designing an extrusion screw, in accordance with the present application;

FIG. 15 is a diagram of a sixth exemplary extrusion screw having a single flight and a channel in a metering zone with an increasing depth;

FIGS. 16a and 16b are diagrams of an exemplary section of the channel of FIG. 15, the exemplary section of the channel of FIG. 15 having a non-uniform depth and a non-uniform width;

FIG. 17 is a diagram of a second exemplary CAD model of the section of the channel of FIG. 15, the section of the channel of FIG. 15 being modeled as a prismatic solid;

FIG. 18 is a diagram a third exemplary CAD model of the section of the channel of FIG. 15, the section of the channel of FIG. 15 being modeled as a rectangular cuboid;

FIGS. 19a and 19b are diagrams of exemplary boundary conditions for the modeling of the section of the channel of FIG. 15 as the rectangular cuboid;

FIG. 20a is a diagram of a seventh exemplary extrusion screw having multiple channels, in which the combined width and depth of channels in a metering zone is increased;

FIG. 20b are diagrams of orthogonal, section, and detail views of the seventh exemplary extrusion screw of FIG. 20a;

FIG. 21 is a diagram of estimates of temperatures of processed feedstock material at locations along a length of the sixth exemplary extrusion screw of FIG. 15 having the single channel, as well as along a length of the seventh exemplary extrusion screw of FIGS. 20a and 20b having the multiple channels;

FIG. 22 is a diagram of estimates of pressures of the processed feedstock material at locations along the length of the sixth exemplary extrusion screw of FIG. 15 having the single channel, as well as along the length of the seventh exemplary extrusion screw of FIGS. 20a and 20b having the multiple channels;

FIG. 23 is a diagram of estimates of specific volumes of the processed feedstock material at locations along the length of the sixth exemplary extrusion screw of FIG. 15 having the single channel, as well as along the length of the seventh exemplary extrusion screw of FIGS. 20a and 20b having the multiple channels;

FIGS. 24a-24c are diagrams of estimates of temperatures, pressures, and specific volumes of processed feedstock material as a function of the rotational speed of an extrusion screw;

FIGS. 25a-25e are diagrams of orthogonal, section, and detail views of an eighth exemplary extrusion screw that includes one (1) feed channel, two (2) transition channels, and four (4) metering channels of varying channel depths;

FIGS. 26a-26d are diagrams of orthogonal and detail views of the eighth exemplary extrusion screw of FIGS. 25a-25e, further including two (2) sets of intermediate mixing flights with different sizes and designs located between a transition zone and a metering zone of the eighth exemplary extrusion screw; and

FIG. 27 is a block diagram of an exemplary computerized apparatus for use in modeling, simulating, analyzing, and/or optimizing an extrusion screw using analytical and/or numerical techniques.

### DETAILED DESCRIPTION

The disclosures of U.S. Provisional Patent Application No. 62/365,550 filed Jul. 22, 2016 entitled EXTRUSION APPARATUS AND METHODS, and U.S. Provisional Patent Application No. 62/263,381 filed Dec. 4, 2015 entitled EXTRUSION SCREWS WITH MULTIPLE CHANNELS, are hereby incorporated herein by reference in their entirety.

Extrusion apparatus and methods are disclosed herein for use in the design and operation of extrusion screws having multiple channels. In one embodiment, an extrusion screw is disclosed that includes a plurality of channels disposed at varying locations along a solid cylinder of the extusion screw for the processing of a feedstock material. The plurality of the channels can have distinct channel widths and distinct channel depths in order to achieve varying design objectives at different axial locations of the extrusion screw. Each of the plurality of channels can transition in channel depth and/or channel width along the length of the extrusion screw, and can have a size and/or shape proportioned relative to the expected size and/or shape of pieces of the feedstock material.

In response to rotations of the disclosed extrusion screw in an extrusion process, the multiple channels of the extrusion screw can control the temperature, pressure, and/or shear rate of the feedstock material flowing through the respective channels in a feed zone, a transition zone, and/or a metering zone of the extrusion screw. The multiple channels of the extrusion screw can be configured to control the temperature, the pressure, and/or the shear rate of the processed feedstock material by being modeled as one or more model objects having one or more predetermined geometries. The models of the respective channels can then be analyzed using one or more computerized analytical and/or numerical techniques in order to obtain at least estimates of desired temperatures, pressures, and/or shear rates of the processed feedstock material, based at least on specified channel lengths, channel widths, and/or channel depths of the respective channel models.

The extrusion apparatus and methods disclosed herein provide a number of benefits relating to the processing of feedstock materials, including, but not limited to, improved dispersion and uniformity of feedstock materials, faster and more efficient processing of feedstock materials, reduced residence times of feedstock materials, more uniform flow rates, temperatures, and/or pressures of feedstock materials, reduced energy consumption, increased energy efficiency, extrusion screw designs having decreased channel lengths and reduced costs, increased and more consistent quality of extrudate materials, and reduced target application development times.

The term “extrusion screw” is used herein to refer to a machine element having principal dimensions defined by a radial dimension and a longitudinal dimension and at least one channel Illustrative embodiments of such an extrusion screw disclosed herein are generally directed to the processing of polymers and composite feedstock materials. It is noted, however, that such illustrative embodiments can alternatively be directed to any other suitable feedstock materials and/or molding processes that incorporate extrusion screws including, but not limited to, injection molding and blow molding.

The term “channel” is used herein to refer to a passageway formed in an extrusion screw through which one or more feedstock materials being processed can flow. Such a channel has a channel length, a channel depth, and a channel width. Further, such a channel can have a rectangular cross-section, tapered side walls, or a varying cross-sectional geometry, as well as fillets at the corners of the channel. Variations in the cross-sectional geometry of such a channel can include changes in the channel depth and/or the channel width, as well as changes in the size and/or shape of the channel. For example, such a channel can transition from a rectangular cross-sectional geometry in a metering zone of the extrusion screw, to an annular cross-sectional geometry at an outlet of the extrusion screw.

In one or more embodiments, such a channel can have an annular cross-sectional geometry defined by a passageway between cylindrical or conical members, particularly at an outlet of an extrusion screw. Exemplary extrusion apparatus and methods described herein can involve at least one channel having such an annular cross-sectional geometry and a corresponding channel depth at a particular location equal to one-half of the difference between an outer diameter and an inner diameter of the extrusion screw, as well as a corresponding channel width at a particular location defined as the value of pi (7c) multiplied by the average of the outer diameter and the inner diameter of the extrusion screw.

The term “multiple channels” is used herein to refer to more than one channel in an extrusion screw. In one or more embodiments, one or more channels can be split, divided into, or formed by multiple channels. It is noted, however, that, in some embodiments, an extrusion screw with one or more channels that are not subsequently split or divided into multiple channels can be beneficial for some target applications, so long as the extrusion screw provides at least two channels in the metering zone of the extrusion screw. In one or more further embodiments, multiple channels in the metering zone can combine or merge into fewer channels (e.g., a single channel) at an outlet of the extrusion screw.

The term “channel depth” is used herein to refer to the distance from the top of a channel to the bottom of the channel in the radial direction of an extrusion screw. Further, the term “channel width” is used herein to refer to the lateral distance of the mid-section of the channel. It is noted that the cross-sectional area of such a channel can vary and can have tapered walls, such that the channel width is not constant as a function of the radial location of the extrusion screw. In addition, the term “channel length” is used herein to refer to the arc length of the centerline of the channel. Such a channel can be defined by a variable pitch helix, and therefore the channel length can vary. In one or more embodiments, the channel depth and/or the channel width are not necessarily constant, but can vary as a function of position along the channel length.

The term “screw design parameters” is used herein to refer to a set of values that define aspects of the design of an extrusion screw, including, but not limited to, the number of channels, the diameter of the extrusion screw, the length of the extrusion screw, the channel width, the channel pitch, the flight width, the flight pitch, and the number of helix rotations of a channel about the extrusion screw.

The term “proximal” is used herein to refer to a starting or closest end of an extrusion screw with respect to the direction of flow of a feedstock material being processed. The term “distal” is used herein to refer to an ending or farthest end of the extrusion screw with respect to the direction of flow of the feedstock material being processed.

The term “upstream” is used herein to refer to the direction from a distal location towards a proximal location of an extrusion screw, and the term “downstream” is used herein to refer to the direction from the proximal location towards the distal location of the extrusion screw.

The term “cooling due to material decompression” is used herein to refer to a reduction in the temperature of a feedstock material being processed by an extrusion screw through a positive change in volumetric expansion. Further, the term “heating due to material compression” is used herein to refer to an increase in the temperature of the processed feedstock material through a negative change in volumetric expansion. It is noted that, in the illustrative embodiments disclosed herein, such cooling and heating due to feedstock material decompression and compression, respectively, are not the exclusive mechanisms for temperature control. Internal shear heating and/or heat conduction between the processed feedstock material, the extrusion screw, and/or the barrel of an extruder can also influence the temperature of the feedstock material.

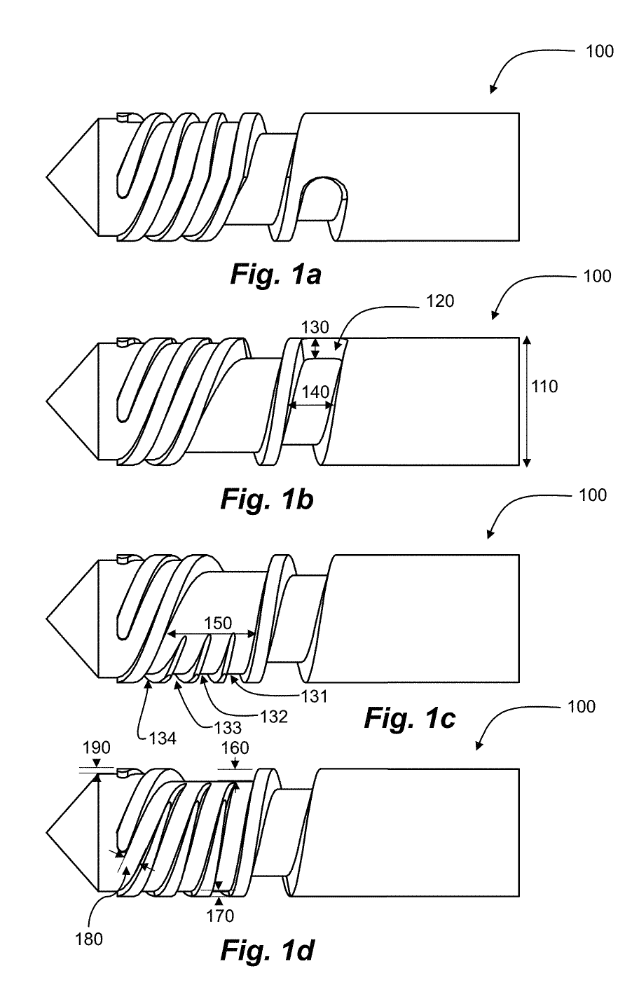

FIGS. 1a-1d depict several views of an illustrative embodiment of an exemplary extrusion screw 100, in accordance with the present application. As shown in FIGS. 1b and 1c, the extrusion screw 100 can include a single feed channel 120, four (4) downstream transition channels 131, 132, 133, and 134, or any other suitable number of channels. The extrusion screw 100 also has a diameter 110; it is noted that the diameter and length of the extrusion screw 100 can vary by target application and/or design objective. In one embodiment, the diameter 110 can be equal to about 31.6 millimeters (mm), allowing the extrusion screw 100 to operate within the barrel of an extruder having a bore diameter equal to about 31.8 mm with 0.1 mm of clearance on each side of the extrusion screw 100. The feed channel 120 can be configured to accept feedstock material such as polymers, composite materials, or any other suitable feedstock material. As shown in FIG. 1b, the feed channel 120 has a channel depth 130 and a channel width 140 that can be selected to accept a desired volume of feedstock material per revolution of the extrusion screw 100, as well as to match the diameter of the feed throat of a hopper (not shown) included in the extruder. As shown in FIGS. 1b-1d, the channel width 140 and the channel depth 130 of the feed channel 120 can transition to a different channel width 150 and a different channel depth 160. For example, the channel width 150 can be selected to be greater than the channel width 140 while the channel depth 160 can be selected to be less than the channel depth 130, such that the cross-sectional area of the feed channel 120 (defined as the product of the channel depth and the channel width at a particular location along the channel) remains constant.

It is noted that a change in the cross-sectional area of a channel of an extrusion screw can affect the compression, the decompression, and/or the conveyance of feedstock material being processed by the extrusion screw. The term “compression ratio” is used herein to refer to the change in a channel's cross-sectional area relative to the initial cross-sectional area of the channel. The concept of a compression ratio is preserved in the illustrative embodiments disclosed herein, taking into account the number of channels and their corresponding channel depths and channel widths. The channel depths and/or the channel widths can be selected to obtain desired design objectives relating to the conveyance, the compression, the decompression, etc., of the feedstock material being processed.

As shown in FIGS. 1b and 1c, the single feed channel 120 can be divided into the four (4) downstream transition channels 131, 132, 133, and 134, or any other suitable number of transition channels. The channel depth and/or the channel width of each transition channel 131, 132, 133, 134 can be selected to accommodate the feedstock material being processed. It is noted that, in conventional extrusion screw designs, the channel depth and/or the channel width in a feed zone and a transition zone of an extrusion screw are typically larger than the size of the feedstock material. As a result, such conventional extrusion screw designs typically allow for the development of a solidified bed of feedstock material in a channel of the feed zone and/or the transition zone that is slow to process. In the extrusion screw 100 of FIGS. 1a-1d, the multiple transition channels 131, 132, 133, 134 provide a means for breaking up such a solidified bed of feedstock material and promptly conveying the feedstock material from the feed zone into the transition zone of the extrusion screw 100. While FIGS. 1a-1d depict the transition from the single feed channel 120 to the four (4) transition channels 131, 132, 133, 134 within two rotations of the extrusion screw 100, it is noted that the feed channel 120 can be lengthened so that the transition from the single feed channel 120 to the four (4) transition channels 131, 132, 133, 134 occurs after two, three, or more rotations of the feed channel 120.

As shown in FIG. 1d, each of the transition channels 131, 132, 133, 134 have a channel depth 170 and a channel width 180, each of which can vary by target application, feedstock material, and/or design objective. It is noted that, if the channel depth 170 and/or the channel width 180 are too small, then a blockage of the feedstock material can occur, causing a reduction in the extrusion processing rate. Conversely, a proportionally larger solidified bed of feedstock material can form in the transition channels 131, 132, 133, 134 with increases in the channel depth 170 and/or the channel width 180. Taking into account such considerations, the channel width 180 can be set to a factor, f1, times the maximum average length of pieces of the feedstock material, and the channel depth 170 can be set to the factor, f1, times the minimum average length of the pieces of the feedstock material. For example, the factor, f1, can have a value between 1 and 10, a value between 1 and 3, or any other suitable value. It is further noted that the feedstock material can take various forms, such as pellets, flakes, granules, beads, etc., and can therefore have different sizes and/or shapes.

As further shown in FIG. 1d, the channel depth of each transition channel 131, 132, 133, 134 can vary from the channel depth 160 at an inlet of each transition channel 131, 132, 133, 134 to the channel depth 170 at an outlet of each transition channel 131, 132, 133, 134. For example, a channel depth 190 at the outlet can be selected to be about one-half of the channel depth 170 at the inlet, such that the compression ratio across each transition channel 131, 132, 133, 134 is equal to about 2. It is noted that different channel depths can be selected depending on the target application and/or design objectives of the extrusion screw 100, as well as the desired compression ratio. It is further noted that the channel width 180 can also vary as a function of position along the channel length, and have a corresponding impact on the compression ratio. Moreover, although FIGS. 1a-1d depict the transition channels 131, 132, 133, 134 having a relatively short length defined by less than two rotations of the respective channels, the transition channels 131, 132, 133, 134 can alternatively be defined by several additional rotations (e.g., up to six or more).

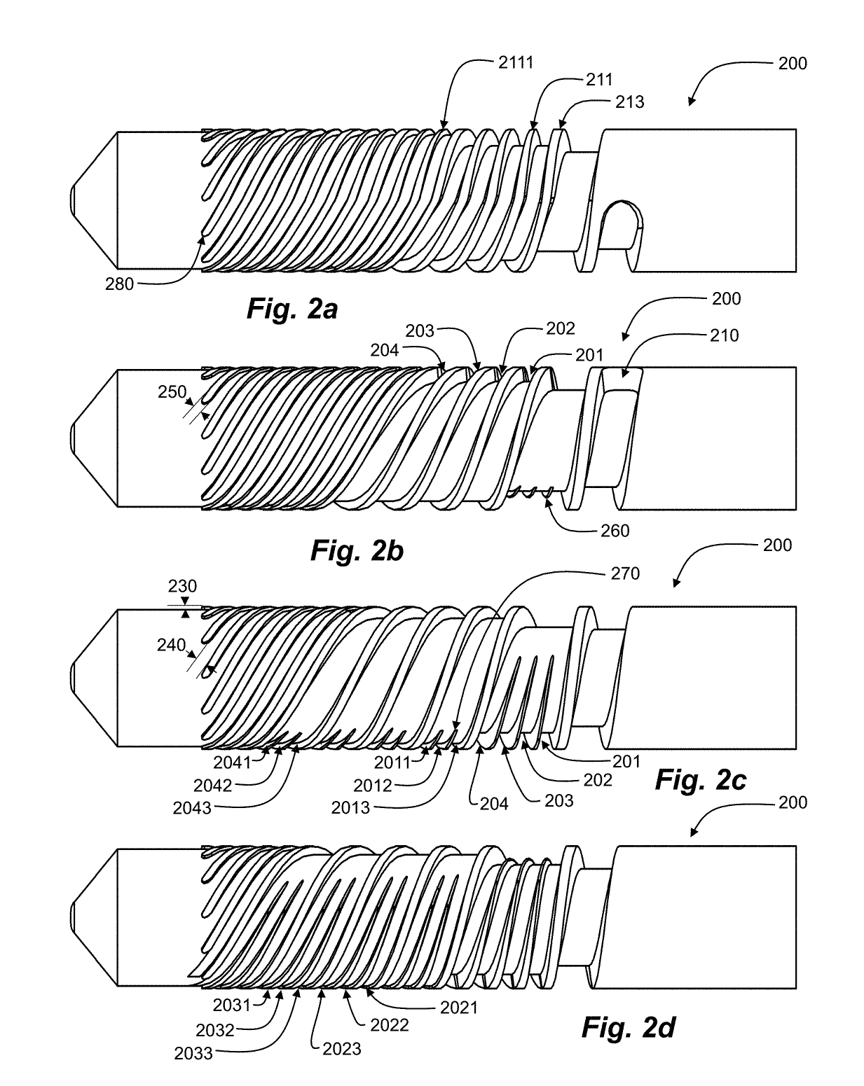

FIGS. 2a-2d depict several views of an illustrative embodiment of an exemplary extrusion screw 200 having the same nominal screw diameter 110 (see FIG. 1b) as the extrusion screw 100, as well as a feed channel 210 having the same channel depth 130 and width 140 (see also FIG. 1b) as the extrusion screw 100. As shown in FIGS. 2b and 2c, the feed channel 210 can be divided into four (4) downstream transition channels 201, 202, 203, and 204 (or any other suitable number of transition channels), each of which can transition to three (3) metering channels (or any other suitable number of metering channels). For example, the transition channel 201 can transition to three (3) metering channels 2011, 2012, and 2013; the transition channel 202 can transition to three (3) metering channels 2021, 2022, and 2023; the transition channel 203 can transition to three (3) metering channels 2031, 2032, and 2033; and, the transition channel 204 can transition to three (3) metering channels 2041, 2042, and 2043, resulting in a total of twelve (12) such metering channels.

As shown in FIG. 2c, each channel in a metering zone of the extrusion screw 200 can have a channel depth 230 and a channel width 240. Further, the channel depth 230 in the metering zone can be less than the channel depth (e.g., the channel depth 170) in a transition zone of the extrusion screw 200, and the channel width 240 in the metering zone can be less than the channel width (e.g., the channel width 180) in the transition zone. It is noted that the channels in the metering zone need not have the same channel depths and/or the same channel widths. If the channel depth and/or the channel width are too small, then a blockage of the feedstock material being processed can occur, causing a reduction in the extrusion processing rate. Further, if the channel depth and/or the channel width are increased, then the feedstock material may not be completely processed and/or homogeneous. Taking into account such considerations, the channel depth 230 can be selected to be a factor, f2, times the minimum average length of pieces of the feedstock material, and the channel width 240 can be selected to be a factor, f3, times the channel depth 230, in which the factors f2 and f3 are not necessarily equal to one another, but can generally be between 1 and 10. It is further noted that the channel depths and/or the channel widths in the metering zone need not be constant, but can vary relative to the channel depths and/or the channel widths in the transition zone (and/or the channel depths and/or the channel widths of other channels in the metering zone) in order to achieve desired design objectives.

As shown in FIG. 2a, the extrusion screw 200 includes a number of flights disposed between the multiple channels, such as a flight 213 disposed between the feed channel 210 and the transition channel 201, a flight 211 disposed between the transition channel 201 and the transition channel 202, and a flight 2111 disposed between the metering channel 2013 and the metering channel 2012. The outer diameters of the respective flights can be selected to provide a nominal clearance between the flights and the bore of the extruder barrel in order to avoid excessive feedstock material leakage (if the clearance is too large), as well as excessive torque and/or wear (if the clearance is too small). Further, the widths of the respective flights are typically on the order of 10% of the screw diameter, but can be any other suitable widths based on the design objectives. The widths of the respective flights 213, 211, 2111 need not be constant. In one embodiment, a nominal clearance of about 0.1 mm can be provided for the respective flights 213, 211, 2111, with a flight width 250 (see FIG. 2b) equal to about 2 mm.

As shown in FIGS. 2a-2c, the various flights (such as the flights 213, 211, 2111) included in the extrusion screw 200 can be provided with one or more fillets, such as fillets 260, 270, and 280. For example, the fillet 260 (see FIG. 2b) can be provided on leading surfaces of starting flights between the inlets of the transition channels 201, 202, 203, 204. Further, the fillet 270 (see FIG. 2c) can be provided on leading surfaces of starting flights between the inlets of the metering channels 2011, 2012, 2013. The fillets 260 and 270 are configured to evenly divide feedstock material without causing excessive wear on the leading surfaces of the starting flights. It is noted that the radiuses of the respective fillets 260, 270 can vary. In one embodiment, the radiuses of the respective fillets 260, 270 can be selected to be about one-fourth of the thickness of the flights at their bases. The fillet 280 (see FIG. 2a) can be provided at trailing edges of the respective flights between the outlets of the metering channels 2011, 2012, 2013 in order to make the flow of the processed feedstock material as smooth as possible, and to avoid the formation of stagnation zones at the outlets of the respective metering channels. Like the fillets 260, 270, the radius of the fillet 280 can vary. In one embodiment, the radius of the fillet 280 can be selected to be about one-half of the thickness of the flights at their respective bases.

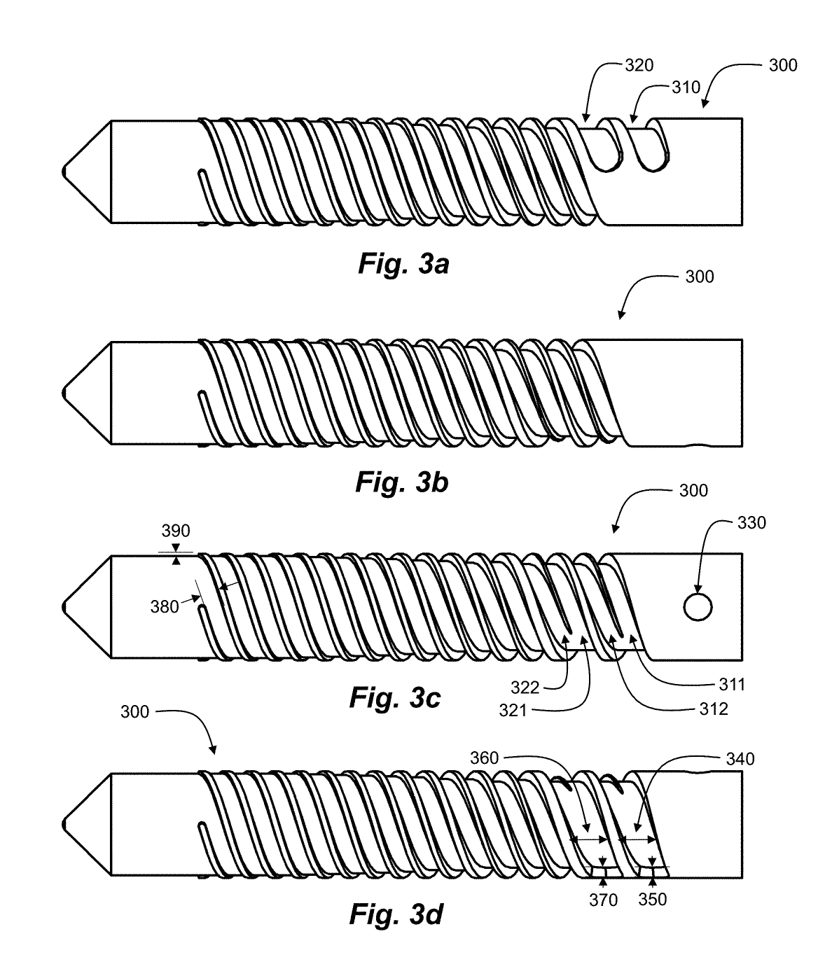

FIGS. 3a-3d depict several views of an illustrative embodiment of an exemplary extrusion screw 300 having the same nominal screw diameter 110 (see FIG. 1b) as the extrusion screw 100, as well as two (2) feed channels 310 and 320. As shown in FIG. 3a, the feed channels 310 and 320 each start at about the same angular position, but at different axial locations on the extrusion screw 300, thereby facilitating the entry of two different feedstock materials into the corresponding feed channels 310, 320. Such different feedstock materials can vary for a number of target applications, and can include the use of various colors, recycled content, additives, and/or molecular weights. The different feedstock materials can also include incompatible feedstock materials. In an extrusion process, such incompatible feedstock materials can be combined at outlets of a plurality of metering channels of the extrusion screw 300 in order to achieve self-assembly of the respective feedstock materials.

As shown in FIG. 3c, the feed channel 310 is split into two (2) transition channels 311 and 312, and the feed channel 320 is likewise split into two (2) transition channels 321 and 322. Each of the four (4) transition channels 311, 312, 321, 322 is then connected directly to a respective metering channel having the same channel width but decreasing channel depth. It is noted that the number of downstream transition channels, as well as their channel widths and/or channel depths, can vary based on the target application and/or design objectives.

It is further noted that the channel width 340 and/or the channel depth 350 of the feed channel 310 can be different from the channel width 360 and/or the channel depth 370 of the feed channel 320. In one embodiment, the feed channel 310 can require an increased channel length between the inlet of the feed channel 310 and the outlet of a corresponding metering channel. In this case, the channel depth 350 can be increased relative to the channel depth 370 in order to obtain a reduced flow resistance and an increased volumetric output from the feed channel 310 relative to the feed channel 320 for the same rotation of the extrusion screw 300. The outlets of the respective metering channels likewise have a channel width 380 and a channel depth 390 that can vary between the respective metering channels. Compared to the extrusion screws 100 and 200, the channels included in the extrusion screw 300 are implemented with additional helix rotations about the central axis of the extrusion screw 300, as well as more gradual transitions in the channel pitch and the channel depth. By specifying the variable pitch helix that defines each channel, any unwanted effects resulting from different channel lengths on an extrusion process can be minimized. In addition, based on the underlying feedstock material properties and extrusion process behavior, the number, depth, and/or width of the channels included in the extrusion screw 300 can be adjusted in order to achieve various processing objectives for different feedstock materials. For example, the number of feed channels can be increased from two to three or more in order to process three or more different feedstock materials. Further, by varying the concentration and/or properties of the feedstock materials, different extrudate morphologies, such as encapsulated spheres, cylinders, gyroid, or lamella, can be obtained.

While feed channels 310 and 320 are configured to start at about the same angular position but different axial locations on the extrusion screw 300, an alternative embodiment of the extrusion screw 300 can have the feed channel 310 start at the same axial location as the feed channel 320, but at an angular position that is offset by 180°. With this alternative embodiment, the inlets of the respective feed channels 310 and 320 can each be provided access to the same feedstock material with every rotation of the extrusion screw 300. A benefit of this alternative embodiment is that the same volumetric output of feedstock material can be achieved with reduced channel depths of the respective feed channels 310, 320. The reduced channel depths reduce the rate at which the channel depths decrease between the feed channels to the metering channels, so as to facilitate the processing of the feedstock material while reducing fluctuations in the flow rate, the pressure, and/or the temperature of the processed feedstock material.

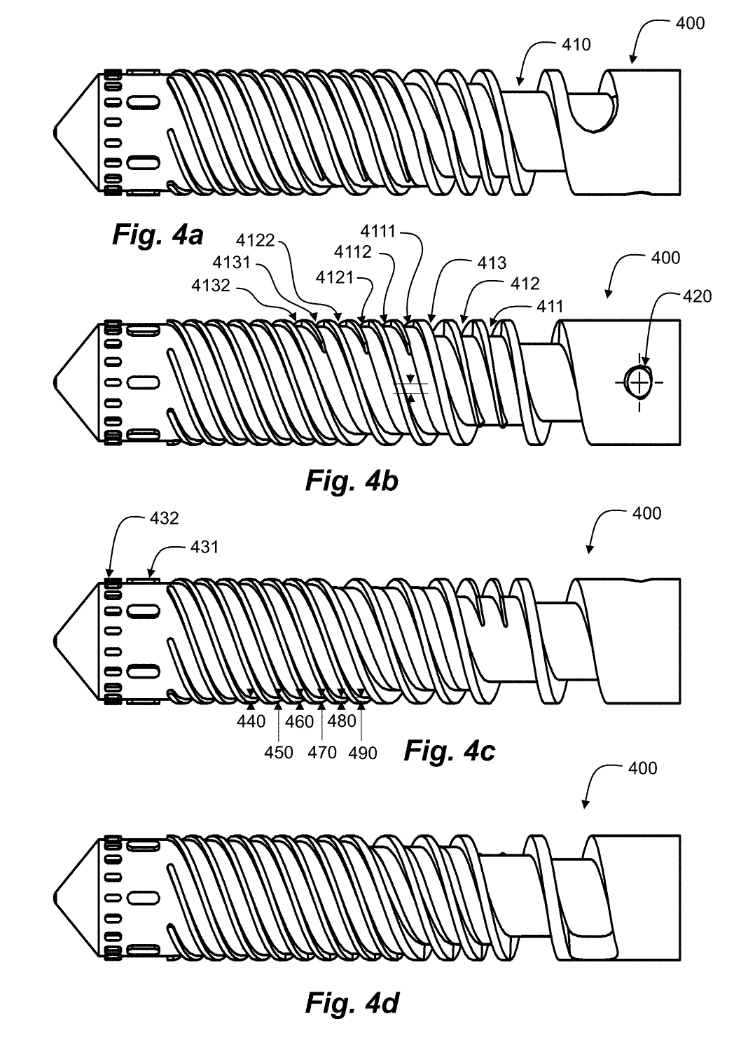

FIG. 4a-4d depict several views of an illustrative embodiment of an exemplary extrusion screw 400 having the same nominal screw diameter 110 (see FIG. 1b) as the extrusion screw 100, as well as a feed channel 410 that is divided into three (3) transition channels 411, 412, and 413, each of which, in turn, is divided into two (2) metering channels. As shown in FIG. 4b, the transition channel 411 is divided into two (2) metering channels 4111 and 4112, the transition channel 412 is divided into two (2) metering channels 4121 and 4122, and the transition channel 413 is divided into two (2) metering channels 4131 and 4132. Each of the outlets of the six (6) metering channels 4111, 4112, 4121, 4122, 4131, 4132 can be specified with the same channel depth in order to provide a uniform root diameter for the extrusion screw 400. However, because of variations between the channel lengths of the respective metering channels 4111, 4112, 4121, 4122, 4131, 4132, variations can also result in the flow rate, the pressure, and/or the temperature of the processed feedstock material. To account for such possible variations in the processed feedstock material, each of the metering channels 4111, 4112, 4121, 4122, 4131, 4132 can be provided with a different channel depth at the location where the metering channel connects with a corresponding upstream transition channel.

In one or more alternative embodiments, the metering channels 4111, 4112, 4121, 4122, 4131, 4132 can be fabricated with channel depths that help to equilibrate the flow rate, the pressure, and/or the temperature of the processed feedstock material, in accordance with the feedstock material properties and/or underlying physics. For example, in the extrusion screw 400, the metering channel 4111 can be provided with a channel depth 490 equal to about 1.6 mm, the metering channel 4112 can be provided with a channel depth 480 equal to about 1.5 mm, the metering channel 4121 can be provided with a channel depth 470 equal to about 1.4 mm, the metering channel 4122 can be provided with a channel depth 460 equal to about 1.3 mm, the metering channel 4131 can be provided with a channel depth 450 equal to about 1.2 mm, and the metering channel 4132 can be provided with a channel depth 440 equal to about 1.1 mm. Further, each of the channel depths 440, 450, 460, 470, 480, 490 can be chosen to linearly decrease as a function of the channel length to about 1 mm, or any other suitable channel depth, at the outlets of the respective metering channels.

As shown in FIG. 4c, the extrusion screw 400 can include a plurality of mixing elements 431 and 432. It is noted that the processed feedstock material exiting the outlets of the metering channels can vary with respect to the flow rate, the pressure, and/or the temperature of the processed feedstock material. For example, if multiple feed channels are employed, such as in the extrusion screw 300, then the composition of the processed feedstock material exiting the outlets of the respective metering channels can vary. Further, certain target applications can require the processed feedstock materials to be mixed before exiting the extruder. For this reason, any suitable number of the mixing elements 431 can be provided downstream of the outlets of the metering channels, and any suitable number of the mixing elements 432 can be provided downstream of the larger mixing elements 431.

In one or more alternative embodiments, the number, location, and/or size of the mixing elements in the extrusion screw 400 can be varied depending on the target application and/or the design objective. For example, a plurality of mixing elements can be provided in the extrusion screw 400 for mixing processed feedstock materials having different colors, recycled content, additives, and/or molecular weights. Such mixing elements can also be provided in the extrusion screw 400 for use with processed incompatible feedstock materials in order to achieve self-assembly of the feedstock material melts. As shown in FIG. 4b, the extrusion screw 400 can further include a tapped hole 420 configured to receive a set screw for securing the extrusion screw 400 relative to a flat section on a rotating shaft geared to a motor of the extruder. Alternatively, the proximal end of the extrusion screw 400 can be provided with a keyway or other suitable feature(s) for fastening the extrusion screw 400 to the rotating shaft.

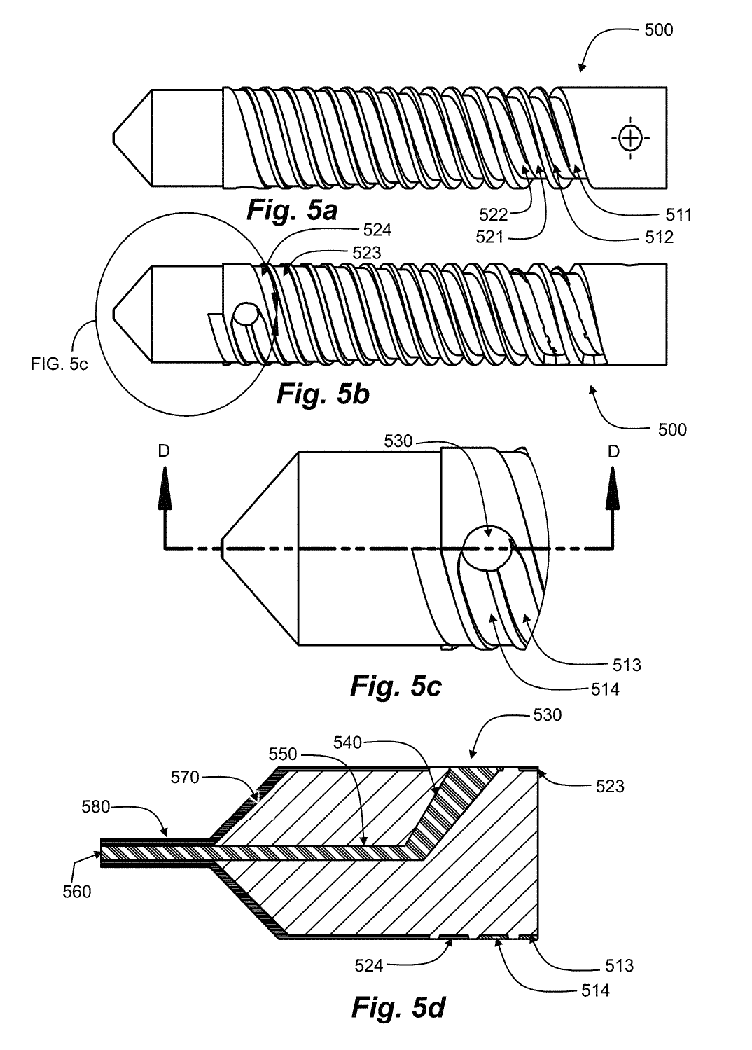

FIGS. 5a and 5b depict several views of an illustrative embodiment of an exemplary extrusion screw 500 that can be used in the coextrusion of products such as film, sheets, tubes, pipes, rods, filaments, etc. FIG. 5c depicts a detail view of a distal end of the extrusion screw 500, and FIG. 5d depicts a cross-sectional view of the distal end of the extrusion screw 500 across a cross-section D-D. For example, a first processed feedstock material can be conveyed through channels 511 and 512 (see FIG. 5a) and ultimately through channels 513 and 514 (see FIG. 5c) of the extrusion screw 500, while a second processed feedstock material can be conveyed through channels 521 and 522 (see FIG. 5a) and ultimately to channels 523 and 524 (see FIG. 5b) of the extrusion screw 500. The first processed feedstock material can then flow through (1) an outlet 530 (see FIG. 5c), (2) an inclined loft 540 (see FIGS. 5d), and (3) a bore 550 (see FIG. 5d) in order to provide a first extrudate layer 560 (see FIG. 5d). Concurrently, the second processed feedstock material conveyed through the channels 523, 524 can recombine at an end 570 (see FIG. 5d) of the extrusion screw 500 where it can form a second extrudate layer 580 (see FIG. 5d). One or more embodiments of the extrusion screw 500 can be configured to accommodate extrusion dies and/or auxiliary equipment for use in the manufacture of film, sheets, tubes, pipes, rods, filaments, and/or any other suitable product. It is noted that there can be some leakage flow through the clearance gap between outer diameters of the flights of the extrusion screw 500 and the inner diameter of the extruder barrel bore. Some leakage flow can be desirable in some target applications in order to facilitate the welding of different feedstock materials. The amount of such leakage flow can be minimized, however, by minimizing the clearance between the respective flights and the extruder barrel bore.

Illustrative computer-aided design methods are described herein for use in designing extrusion screws that can satisfy the design objectives of various target applications. In such illustrative computer-aided design methods, 3-dimensional computer-aided design (CAD) software can be employed in order to provide a CAD model of an extrusion screw design based on a predetermined set of screw design parameters. In one illustrative method, a CAD model of a cylindrical solid having a diameter equal to the outer diameter of an extrusion screw can be provided, after which various cuts can be made in the cylindrical solid in order to provide one or more channels in the extrusion screw. In another illustrative method, a CAD model of a cylindrical solid having a diameter equal to the root diameter of an extrusion screw can be provided, after which various protrusions can be added to the cylindrical solid in order to provide one or more flights, as well as specify one or more channel depths, in the extrusion screw.

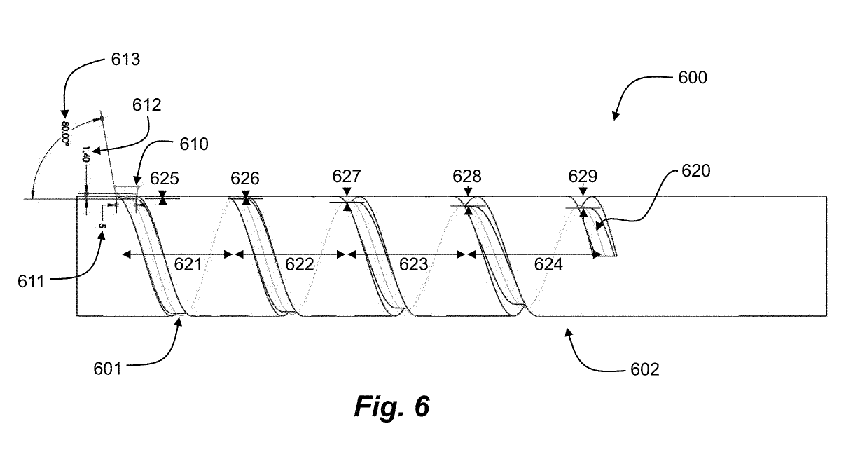

FIG. 6 depicts an illustrative embodiment of an exemplary CAD model 600 of an extrusion screw design, in accordance with the present application. As shown in FIG. 6, the CAD model 600 includes a cylindrical solid 602 having a channel 601. Using suitable 2-dimensional or 3-dimensional CAD software, the channel 601 can be helically swept cut in the cylindrical solid 602 by sweeping a channel cross-section 610 along a variable pitch helix 620. For example, the channel cross-section 610 can be defined as a trapezoid or any other suitable geometric shape (e.g., a rectangle), having a width 611 (e.g., 5 mm), a height 612 (e.g., 1.4 mm), and a pair of walls, each being disposed at an inclined angle 613 (e.g., 80°).

In the CAD model 600 of the extrusion screw design, various computer-aided design methods can be employed for obtaining the channel 601 in the cylindrical solid 602. As described herein, the channel 601 can be a helically swept cut in the cylindrical solid 602 using the channel cross-section 610, with the variable pitch helix 620 being defined relative to the center of the cross-sectional area of the channel 601. As shown in FIG. 6, the trapezoidal cross-section of the channel 601 can be located on the diameter of the cylindrical solid 602, with its height 612 selected to be equal to twice the channel depth at that location. In one embodiment, the height 612 can be selected to be equal to 1.4 mm in order to provide a channel depth of 0.7 mm at the outlet of the channel 601. The height 612 can then be outwardly extended from the centerline of the cylindrical solid 602 in order to enable the cutting of one or more deeper channels in the cylindrical solid 602 along the variable pitch helix 620.

In the CAD model 600 (see FIG. 6), the variable pitch helix 620 can be used to define the channel pitch, the channel depths, and the channel widths of the various channels in the cylindrical solid 602. As shown in FIG. 6, the channel 601 can make four revolutions about the cylindrical solid 602 with a plurality of specified channel pitches 621, 622, 623, and 624. The diameter of the variable pitch helix 620 at each revolution can be specified to provide a plurality of channel depths 625, 626, 627, 628, and 629. The specified channel pitches 621, 622, 623, 624 and the diameter of the variable pitch helix 620 at each revolution can be specified to obtain the desired extrusion screw geometry from the upstream continuation of the swept downstream channels. For example, a feed channel (such as the feed channel 310; see FIG. 3a) can be created from the merging of a plurality of channels (such as the channels 311 and 312; see FIG. 3c) with variable pitches. In this way, a larger upstream channel can be obtained from the merger of two or more smaller downstream channels. With reference to FIG. 6, the various pitches of the variable pitch helix 620, as well as various channel widths and various channel depths, can be specified at arbitrary locations along the axis of the cylindrical solid 602 for the purpose of merging two or more channels into a single channel, as well as dividing one or more channels into multiple channels. By merging channels across multiple revolutions of the channels about the cylindrical solid 602, any unwanted effects resulting from different channel lengths on an extrusion process can be minimized.

It is noted that the variable pitch helix 620 can be initiated at various angular positions along the cylindrical solid 602, and can be provided with a varying number of turns, channel pitches, and/or diameters in order to achieve a desired extrusion screw design. For example, the design of the extrusion screw 300 (see FIG. 3) can be obtained in such a manner, using the specifications of the various flights 321, 312, 311, 324 provided in TABLE 1 below.

TABLE 1

| | | | | |
|---|---|---|---|---|
| Pitch | Revolution | Height | Depth | Diameter |

Flight 321, starting at 0 degrees

| | | | | |
|---|---|---|---|---|
| 28.50 | 0.00 | 0.00 | 0.70 | 31.70 |
| 28.50 | 1.00 | 28.50 | 0.70 | 31.70 |
| 29.00 | 2.00 | 57.25 | 1.55 | 30.00 |
| 31.50 | 3.25 | 95.06 | 3.05 | 27.00 |
| 25.00 | 4.25 | 123.31 | 3.05 | 27.00 |

Flight 312, starting at 90 degrees

| | | | | |
|---|---|---|---|---|
| 28.50 | 0.00 | 0.00 | 0.70 | 31.70 |
| 28.50 | 1.00 | 28.50 | 0.70 | 31.70 |
| 29.00 | 2.00 | 57.25 | 1.55 | 30.00 |
| 31.00 | 3.00 | 87.25 | 3.05 | 27.00 |
| 33.00 | 4.50 | 135.25 | 3.05 | 27.00 |

Flight 311, starting at 180 degrees

| | | | | |
|---|---|---|---|---|
| 28.50 | 0.00 | 0.00 | 0.70 | 31.70 |
| 28.50 | 1.00 | 28.50 | 0.70 | 31.70 |
| 29.00 | 2.00 | 57.25 | 1.55 | 30.00 |
| 31.50 | 3.75 | 110.19 | 3.05 | 27.00 |
| 21.00 | 4.75 | 136.44 | 3.05 | 27.00 |

Flight 324, starting at 270 degrees

| | | | | |
|---|---|---|---|---|
| 28.50 | 0.00 | 0.00 | 0.70 | 31.70 |
| 28.50 | 1.00 | 28.50 | 0.70 | 31.70 |
| 29.00 | 2.00 | 57.25 | 1.55 | 30.00 |
| 32.00 | 3.00 | 87.75 | 3.05 | 27.00 |
| 32.50 | 4.00 | 120.00 | 3.05 | 27.00 |

Any suitable computer-aided design methods can be employed for designing the various extrusion screws described herein. For example, such a computer-aided design method can be used to provide a CAD model of an extrusion screw by cutting a cylindrical solid in order to obtain at least one channel with a swept loft defined by a starting channel section, an ending channel section, and an intermediate channel path, which, in turn, can be defined as a variable pitch helix connecting the center of the starting channel section to the center of the ending channel section.

In another embodiment, a computer-aided design method can employ an application programming interface (API) implemented using, for example, Microsoft VisualBasic™ for Applications in conjunction with SolidWorks™ 2015, for programmatically generating the CAD model 600 of the extrusion screw design illustrated in FIG. 6. Such an API can be employed to programmatically generate the channel cross-section 610 with the variable pitch helix 620 used in cutting the channel 601 in the cylindrical solid 602. Such an API can also be employed to programmatically generate CAD models of the respective extrusion screw designs illustrated in FIGS. 1, 2, and 4, based on predetermined sets of screw design parameters indicated in TABLE 2 below.

With regard to TABLE 2, it is noted that (1) the variable “iDesign=1” designates the extrusion screw design illustrated in FIG. 1, (2) the variable “iDesign=2” designates the extrusion screw design illustrated in FIG. 2, (3) the variable “iDesign=4” designates the extrusion screw design illustrated in FIG. 4, (4) the variable “nChildren” defines the number of downstream channels relative to the number of upstream channels in the respective extrusion screw designs, (5) the variable “MeterDepths” defines varying channel depths for the metering channels in the respective extrusion screw designs, and (6) the Boolean variable “bClockWise” specifies the direction of helix rotation of the various channels in the respective extrusion screw designs. With reference to the variable “iDesign=4” designating the extrusion screw design illustrated in FIG. 4, the variable “MeterDepths” defines the varying channel depths 490, 480, 470, 460, 450, 440 of the metering channels 4111, 4112, 4121, 4122, 4131, 4132, respectively. With further regard to TABLE 2, it is noted that the variables “Flight_Thickness”, “ChannelWidth”, “Channel Depth”, and “ChannelRevolutions” define the flight thickness, the channel width, the channel depth, and the number of channel revolutions, respectively, for each channel included in the respective extrusion screw designs of FIGS. 1, 2, and 4.

TABLE 2

If iDesign = 1 Then

′ 3-0-0 Screw (Design 1)
nChildren = Array(4, 0, 0, 0, 0)
Flight_Thickness = Array(8, 7, 0, 0)
ChannelWidth = Array(15, 7.2, 0, 0, 0)

ChannelDepth = Array(8, 2, 0, 0, 0)

ChannelRevolutions = Array(1, 1, 0, 0, 0)
bClockWise = False

ElseIf iDesign = 2 Then

′ 4 x 4 Screw (Design 2)
nChildren = Array(4, 3, 0, 0, 0)
Flight_Thickness = Array(8, 6, 4, 0)
ChannelWidth = Array(15, 6, 5, 0, 0)
ChannelDepth = Array(8, 5, 1, 0, 0)
ChannelRevolutions = Array(1, 1, 1, 0, 0)
bClockWise = False

ElseIf iDesign = 4 Then

′ 3 x 2 Screw (Design 3)
nChildren = Array(3, 2, 0, 0, 0)
Flight_Thickness = Array(5, 3, 2, 0)
ChannelWidth = Array(15, 5, 4, 4, 0)
ChannelDepth = Array(6, 4, 1.25, 1, 0)
ChannelRevolutions = Array(1, 1, 1, 1, 0)
MeterDepths = Array(1.6, 1.5, 1.4, 1.3, 1.2, 1.1)
bClockWise = False

End If

In another embodiment, the extrusion screw designs of FIGS. 1, 2, and 4 can be produced using numerically-controlled metal cutting machines, in accordance with standard manufacturing practices. For example, Mastercam™ CAD/CAM software can be employed to provide numerical instructions to a milling machine for the machining of the geometries of the various extrusion screw designs with various cutting tools. The various extrusion screw designs can then be polished, heat-treated, and plated, in further accordance with standard manufacturing practices.

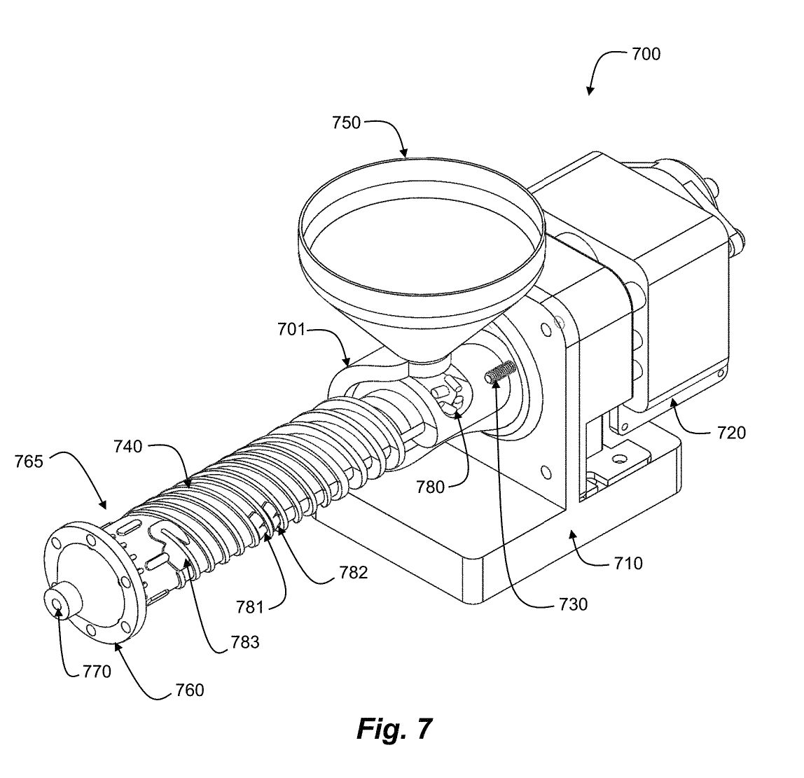

FIG. 7 depicts an illustrative embodiment of an exemplary extruder 700, which can be used in conjunction with each of the extrusion screws 100, 200, 300, 400, 500 described herein. As shown in FIG. 7, the extruder 700 includes a representative extrusion screw 740, an extruder barrel 701, a mount 710, a motor 720, one or more fasteners 730, a hopper 750, and an end cap 760 with an extrusion die orifice 770. For example, the representative extrusion screw 740 can be like the extrusion screw 400 of FIG. 4. It is noted that the extruder barrel 701 is illustrated in FIG. 7 in a cut-away fashion in order to reveal the extrusion screw 740 and multiple pellets 780-782 of feedstock material being processed. The extruder barrel 701 can be attached to the mount 710 and the end cap 760 with suitable fasteners, heaters, and/or other components, which are omitted from FIG. 7 for clarity of illustration. The shaft of the motor 720, the mount 710, the extruder barrel 701, the extrusion screw 740, and the end cap 760 can be designed to be compatible with regard to their respective lengths and diameters. Further, the speed, the torque, and the power of the motor 720 can be selected to meet the objectives of the target application, as subsequently described herein with respect to certain analytical considerations.

The feedstock material, in the form of pellets or any other suitable form, can be provided to the feed channel (not numbered) of the extrusion screw 740 via the hopper 750 and a corresponding passageway in the extruder barrel 701. Four (4) exemplary pellets 780 of the feedstock material in the feed channel are shown in FIG. 7 for purposes of illustration. It is noted, however, that a multitude of such pellets can be provided to the feed channel from the hopper 750. As the motor 720 causes the extrusion screw 740 to rotate within the extruder barrel 701, the flights of the extrusion screw 740 apply forces to the pellets 780 of feedstock material, thereby moving the pellets 780 from the inlet to the outlet of each channel of the extrusion screw 740.

More specifically, the forces applied by the flights of the extrusion screw 740 move the pellets 780 of feedstock material from the inlet to the outlet of the feed channel, at which point the pellets 780 are divided among a plurality of transition channels (not numbered). As the pellets 780 move through the various channels of the extrusion screw 740, the extruder barrel 701, the extrusion screw 740, as well as other pellets of feedstock material moving through the various channels, apply forces that cause the pellets 780 to heat, deform, and flow. For example, the pellets can form a queue in the respective channels, as illustrated by the pair of pellets 781 and the pair of pellets 782. Such queueing of the pellets 781, 782 in the channels of the extrusion screw 740 can be beneficial because it can promote efficient and uniform processing of the feedstock material. Ultimately, viscous heating within the processed feedstock material, combined with the effects of conduction and convection within the extruder barrel 701, cause the pellets 780, 781, 782 to melt. The continuing conveyance of the processed feedstock material along the channels of the extrusion screw 740, due to the rotation of the extrusion screw 740 within the extruder barrel 701, causes processed feedstock material 783 to recombine at the outlets of the metering channels (not numbered) of the extrusion screw 740. The recombined processed feedstock material 783 can then proceed through multiple mixing elements 765 of the extrusion screw 740.

It is noted that continued processing of the pellets of feedstock material (such as the pellets 780, 781, 782) through the channels of the extrusion screw 740 can cause the volume within the extruder barrel 701 not occupied by the extrusion screw 740 to fill with processed feedstock material. As a result, pressure can develop within the extruder barrel 701 adjacent the end cap 760. Such pressurization of the processed feedstock material at the end cap 760 can be used to force the processed feedstock material through the extrusion die orifice 770. In one embodiment, the extrusion die orifice 770 can be configured as an exemplary cylindrical passageway with a length of about 10 mm and a diameter of about 3.0 mm.

The disclosed extrusion apparatus and methods will be further understood with reference to an illustrative analysis of the extrusion of polymeric feedstock material (e.g., casting wax) by an extruder, taking into account certain effects related to shear deformation, transient heating, and viscous flow. Such an illustrative analysis can be performed in order to study the expected behavior of the extruder as it processes the polymeric feedstock material, as well as assist in the selection of one or more screw design parameters, including, but not limited to, the number of channels, the channel width, the channel length, and the channel pitch for one or more channels of an extrusion screw incorporated into the extruder.

As part of this illustrative analysis, the physics of the conveyance of the polymeric feedstock material along multiple channels of the extrusion screw are modeled, simulated, analyzed, and/or optimized using a predetermined computerized analytical or numerical technique in order to obtain at least estimates of the desired flow rate, temperature, and/or pressure of the processed polymeric feedstock material, based on one or more screw design parameters such as the channel length, the channel width, and the channel depth. It is noted that unwanted effects of variations in the channel lengths can be minimized by a selection of one or more of the screw design parameters, such as the channel pitch, the channel width, the number of channels, and/or the number of helix rotations of the respective channels about the extrusion screw. The effects of such variations in the channel lengths on an extrusion process can also be controlled through a selection of one or more of the screw design parameters, such as the channel width and the channel depth. It is further noted that both the width and the depth of each channel of the extrusion screw can vary as a function of position along the length of the channel.

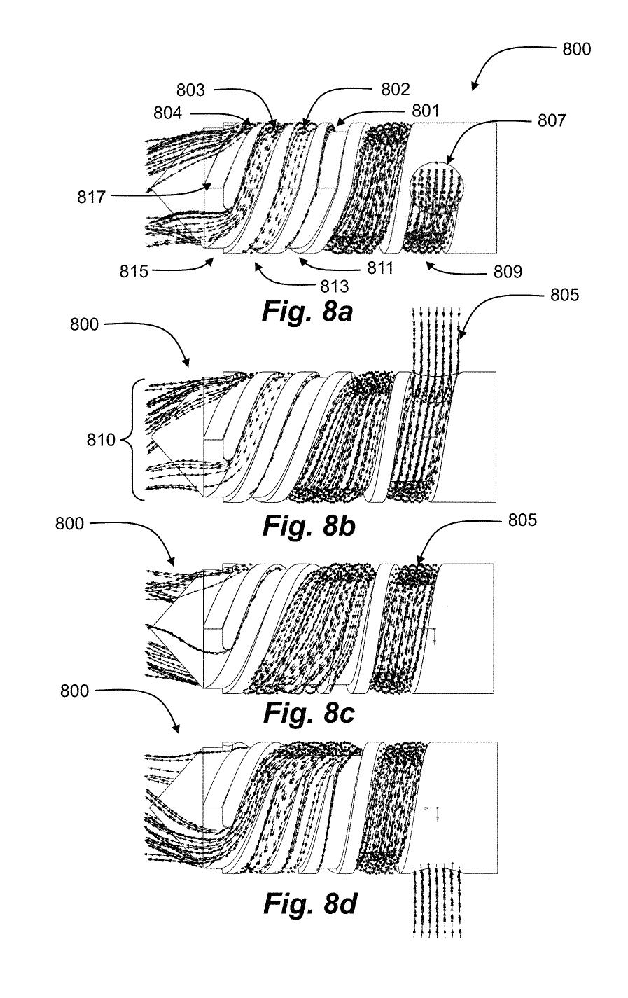

This illustrative analysis of the extrusion of polymeric feedstock material is further described below with reference to the following illustrative example and FIGS. 8a-8d, which depict several views of an extrusion screw 800, as well as a numerical simulation display of the conveyance of polymeric feedstock material 805 along multiple channels 809, 811, 813, 815, 817 of the extrusion screw 800. It is noted that the extrusion screw 800 is like the extrusion screw 100 of FIGS. 1a-1d. In this illustrative example, the effects of variations in the channel lengths of the extrusion screw 800 on a process of extruding the polymeric feedstock material 805 are analyzed. Further, the physics of the conveyance of the polymeric feedstock material 805 along the respective channels 809, 811, 813, 815, 817 of the extrusion screw 800 are modeled, simulated, and/or analyzed using a predetermined computerized analytical or numerical technique, which, for example, can be implemented using Flow Simulation 2015 SP2 software sold by Dassault Systems. As shown in FIGS. 8a-8d, an inlet flow of the polymeric feedstock material 805 is provided through a feed port 807 to the feed channel 809 of the extrusion screw 800. The polymeric feedstock material 805 conveyed in the feed channel 809 is then divided into four (4) streams 801, 802, 803, 804 of polymeric feedstock material, which are provided to the four (4) transition channels 811, 813, 815, 817, respectively, of the extrusion screw 800. The four (4) streams 801, 802, 803, 804 of polymeric feedstock material are subsequently recombined at the end of the extrusion screw 800, resulting in processed polymeric feedstock material 810.

In the foregoing illustrative example, the channel lengths of the transition channels 815 and 817 (which correspond to the transition channels 133 and 134, respectively; see FIG. 1c) are configured to be less than the channel lengths of the transition channels 811 and 813 (which correspond to the transition channels 131 and 132, respectively; see FIG. 1c). The processed polymeric feedstock material 810 provided at the end of the extrusion screw 800 therefore consists mainly of the polymeric feedstock material from the streams 803, 804 conveyed in the transition channels 815, 817, respectively. As indicated herein, variations in the channel lengths of the respective transition channels 811, 813, 815, 817 can be reduced or effectively eliminated by a selection of one or more of the screw design parameters, such as the channel pitch, the channel width, the number of channels, and the number of helix rotations of the respective channels about the extrusion screw 800.

The disclosed embodiments of the extrusion screws 100, 200, 300, 400, 500 can be modeled, simulated, analyzed, and/or optimized in order to achieve increased uniformity in the flow rate, the pressure, and/or the temperature of feedstock material being processed by the respective extrusion screws. To that end, the temperature, T, as a function of the radial position, r, within the processed feedstock material can be modeled as a function of time, t, using the following heat equation expressed in cylindrical coordinates:

$$ρ C \frac{\partial T}{\partial t} = \frac{1}{r} \frac{\partial }{\partial t} ( rk \frac{\partial T}{\partial r} ) + q = k ( \frac{1}{r} \frac{\partial T}{\partial r} + \frac{{\partial }^{2} T}{\partial {r}^{2}} ) + q , \qquad ( 1 )$$

in which “ρ”, “C”, and “k” correspond to the density, the specific heat, and the thermal conductivity, respectively, and “q” corresponds to the internal heat generation due to viscous heating or the heat loss due to enthalpy of fusion, which can be modeled by varying the specific heat, C, as a function of the temperature, T. It is noted that a convective or other boundary condition can be provided at the wall of the extruder barrel in order to model the heat flux between the processed feedstock material and the extrusion screw or the extruder barrel.

The viscous heating due to shearing of the processed feedstock material can be modeled as follows:

g_{shearing}=η(T,\dot{γ})\dot{γ}², (2)

in which “η” corresponds to the apparent viscosity of the feedstock material being sheared, and “\dot{γ}” corresponds to the rate of shear deformation in the processed feedstock material. As shown in equation (2), the apparent viscosity, can be expressed as a function of the states of the processed feedstock material, including at least the temperature, T, and the shear rate, \dot{γ}. It is noted that the apparent viscosity, can alternatively be expressed as a function of the temperature, the shear rate, the molecular weight, the pressure, the orientation, and/or the processing history of the feedstock material.

In this illustrative analysis, the rheology of the feedstock material (e.g., casting wax) at a shear rate of about 50 reciprocal seconds can be used for analysis and prototyping purposes. It is noted that the Williams-Landel-Ferry (WLF) temperature model can overpredict the viscosity of such casting wax at low temperatures, and therefore the following sigmoidal function can alternatively be employed:

$$η ( T , \dot{γ} ) = ( {η}_{0} + \frac{( {η}_{∞} - {η}_{0} ) ( T - {T}_{50} )}{2 \sqrt{1 + {( T - {T}_{50} )}^{2}}} ) {\dot{γ}}^{1 - n} , \qquad ( 3 )$$

in which “η₀” corresponds to the viscosity at low temperature (e.g., 1·10⁵ cP), “η_{∞}” corresponds to the viscosity at high temperature (e.g., 25 cP), “T₅₀” corresponds to the temperature at which the viscosity is equal to its mid-value (e.g., 49.7° C.), and “n” corresponds to the power law index (e.g., 0.4).

The overall performance of the extrusion screw can be evaluated by comparing its efficiency relative to the total power required to plasticate and pump the casting wax. The plastication power, p_{melting}, for a nomimal flow rate, Q, a density, ρ, an enthalpy of fusion, H, a heat capacity, CP, and a change in polymer temperature, ΔT, can be estimated as follows:

$${p}_{melting} \approx Q ρ ( \overbrace{H / ρ}^{Melting} + \overbrace{{C}_{P} Δ T}^{Heating} ) . \qquad ( 4 )$$

Further, the pumping power, p_{pumping}, for an extrusion pressure, P, can be estimated as follows:

P_{pumping}≈QP. (5)

The nominal flow rate, Q, for the extrusion screw rotating at a given number of revolutions per minute (RPM) can also be estimated, taking into account one or more screw design parameters such as the outer screw diameter, OD, the channel depth, D, of the feed channel, and the channel width, W, of the feed channel, as follows:

Q=π/4(OD−D(WD)RPM. (6)

With regard to equation (6), it can be assumed that the flight of the feed channel (such as the feed channel 120, 809; see FIGS. 1b, 8a) is half-filled with new polymeric feedstock material with each rotation of the extrusion screw, with an allowance for the feedstock material (e.g., pellet) packing density, any unfed feedstoack material at the bottom of the extruder barrel, and/or any other inefficiencies that might occur at the inlet to the feed channel. It is noted that the flow rate condition can be adjusted at the inlet of the feed channel, in accordance with the depth and the width of the feed channel in order to achieve various design objectives.

With regard to this illustrative analysis, one or more illustrative transient analyses can also be performed by modeling the extrusion screw using a finite difference method, taking into account the viscosity of the processed polymeric feedstock material (e.g., casting wax), as described herein. With reference to the extrusion screw 400 of FIGS. 4a-4d, the conveyance of the polymeric feedstock material from the feed channel 410, through the downstream transition channels 411, 412, 413, and to downstream metering channels 4111, 4112, 4121, 4122, 4131, 4132 can be so modeled, with the pressure, the flow rate, and the temperature states of the polymeric feedstock material at the outlet of each channel being assigned the inlet conditions of its corresponding downstream channel. Each of the feed channel 410, the transition channels 411, 412, 413, and the metering channels 4111, 4112, 4121, 4122, 4131, 4132 can also be discretized into a subsection having a discrete channel length, a discrete channel width, and a discrete channel depth. Further, the shear rate, the temperature, and the viscosity can be iteratively determined within each channel subsection in order to assure numerical convergence, as well as increased accuracy, of the modeling of the extrusion screw design.

For example, two sets of illustrative transient analyses can be conducted for the design of the extrusion screw 400. In a first transient analysis, the channel depths 490, 480, 470, 460, 450, 440 of the metering channels 4111, 4112, 4121, 4122, 4131, 4132, respectively, can each be selected to be equal to 1 mm. The first transient analysis can be conducted assuming a flow rate of 0.2 cubic centimeters per second at the inlets of the respective metering channels, for casting wax having a density of 800 kg/m³ and a specific heat of 2000 J/kg K.

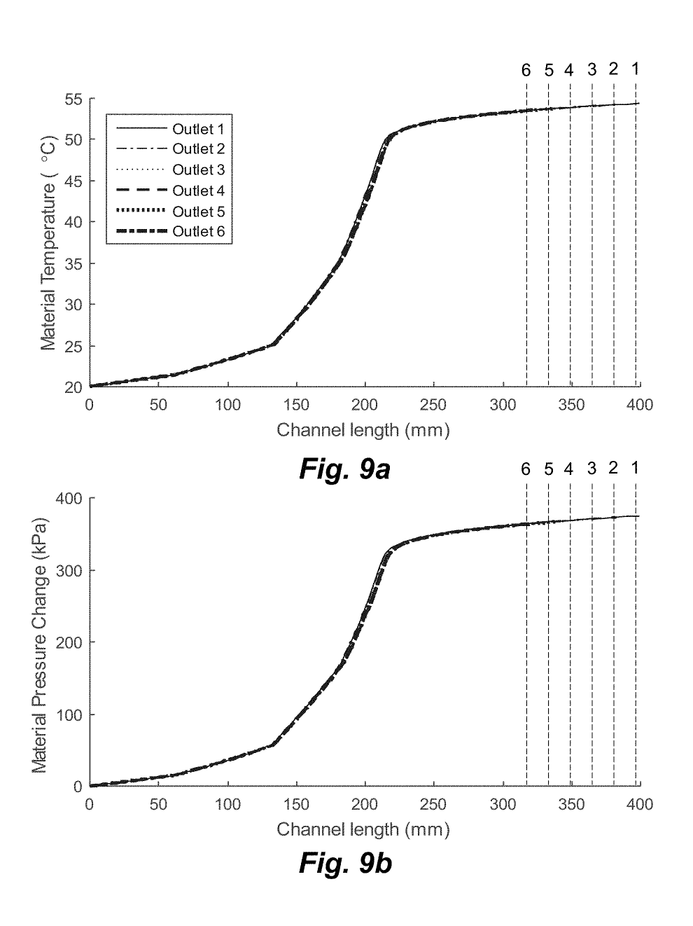

FIG. 9a depicts a graphical representation of exemplary estimates of the temperatures of the processed polymeric feedstock material at locations along the combined lengths of the transition and metering channels of the extrusion screw 400, in which each metering channel 4111, 4112, 4121, 4122, 4131, 4132 has a channel depth of 1 mm. It is noted that, in FIG. 9a, outlets 1, 2, 3, 4, 5, 6 correspond to the outlets of the metering channels 4111, 4112, 4121, 4122, 4131, 4132, respectively, at corresponding locations along the combined channel lengths. As shown in FIG. 9a, the estimated temperature of the processed polymeric feedstock material starts at about room temperature (20° C.), and increases as the processed polymeric feedstock material is conveyed along the transition and metering channels of the extrusion screw 400, due to the shearing of the polymeric feedstock material. FIG. 9b depicts a graphical representation of exemplary estimates of changes in pressure for processing the polymeric feedstock material at the same locations along the combined channel lengths of the extrusion screw 400.

As shown in FIGS. 9a and 9b, the processed polymeric feedstock material being conveyed along each combined channel follows similar trajectories in estimated temperatures (see FIG. 9a) and estimated changes in pressure (see FIG. 9b). It is noted that the slope of the temperature trajectory (see FIG. 9a), as well as the slope of the changes in pressure trajectory (see FIG. 9b), are the greatest in the transition channels 411, 412, 413 (e.g., at locations ranging from about 150 mm to 250 mm along the combined channel length) where the polymeric feedstock material is being processed at lower temperatures. At such lower temperatures, the polymeric feedstock material tends to have a greater viscosity, resulting in an increase in the required pressure for processing the polymeric feedstock material, and a concomitant increase in viscous heating. Once the processed polymeric feedstock material is heated, the viscosity of the polymeric feedstock material is reduced, resulting in a stabilization of the temperatures and pressures of the polymeric feedstock material in the metering channels 4111, 4112, 4121, 4122, 4131, 4132 (e.g., at locations ranging from about 300 mm to 400 mm along the combined channel length).

In a second transient analysis, the channel depth 490 of the metering channel 4111 is selected to be equal to 1.6 mm, the channel depth 480 of the metering channel 4112 is selected to be equal to 1.5 mm, the channel depth 470 of the metering channel 4121 is selected to be equal to 1.4 mm, the channel depth 460 of the metering channel 4122 is selected to be equal to 1.3 mm, the channel depth 450 of the metering channel 4131 is selected to be equal to 1.2 mm, and the channel depth 440 of the metering channel 4132 is selected to be equal to 1.1 mm Like the first transient analysis, the second transient analysis can be conducted assuming a flow rate of 0.2 cubic centimeters per second at the inlets of the respective metering channels, for casting wax having a density of 800 kg/m³ and a specific heat of 2000 J/kg K.

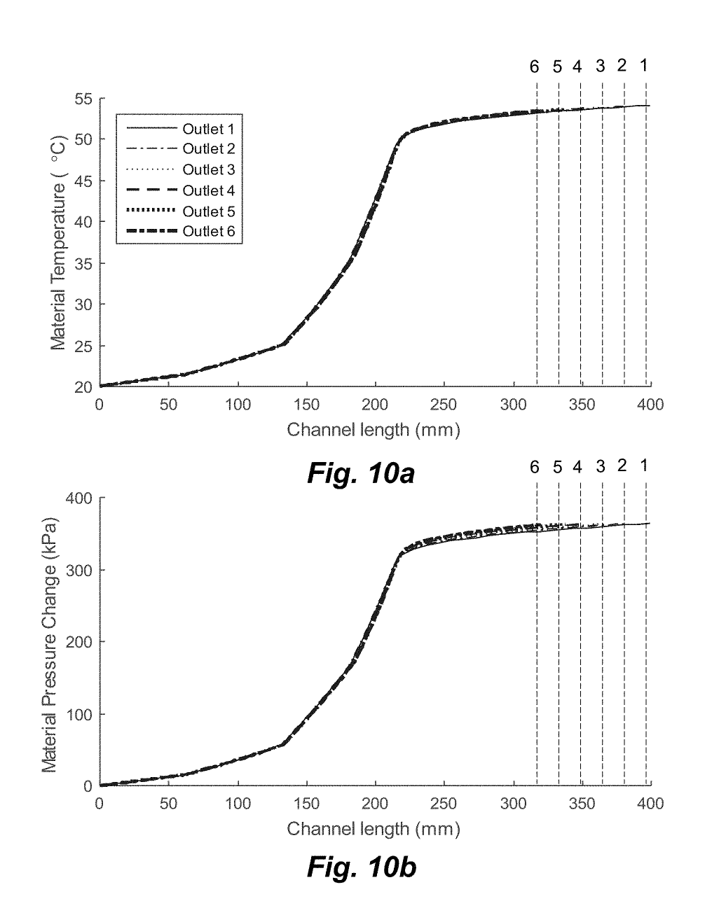

FIG. 10a depicts a graphical representation of exemplary estimates of the temperatures of the processed polymeric feedstock material at locations along the combined channel lengths of the transition and metering channels of the extrusion screw 400, in which the metering channels 4111, 4112, 4121, 4122, 4131, 4132 have varying channel depths ranging from 1.1 mm to 1.6 mm FIG. 10b depicts a graphical representation of exemplary estimates of changes in pressure for processing the polymeric feedstock material at the same locations along the combined channel lengths of the extrusion screw 400. As in FIGS. 9a and 9b, the outlets 1, 2, 3, 4, 5, 6 depicted in each of FIGS. 10a and 10b correspond to the outlets of the metering channels 4111, 4112, 4121, 4122, 4131, 4132, respectively, at corresponding locations along the combined channel lengths. As shown in FIG. 10a, the estimated temperature of the processed polymeric feedstock material starts at about room temperature (20° C.), and increases as the processed polymeric feedstock material is conveyed along the transition and metering channels of the extrusion screw 400, due to the shearing of the polymeric feedstock material.

As shown in FIGS. 10a and 10b, the processed polymeric feedstock material being conveyed along each combined length of the transition and metering channels of the extrusion screw 400 follows similar trajectories in estimated temperatures (see FIG. 10a) and estimated changes in pressure (see FIG. 10b). Further, the slope of the temperature trajectory (see FIG. 10a), as well as the slope of the changes in pressure trajectory (see FIG. 10b), are the greatest in the transition channels 411, 412, 413 (e.g., at locations ranging from about 150 mm to 250 mm along the combined channel length) where the polymeric feedstock material is being processed at lower temperatures. At such lower temperatures, the polymeric feedstock material tends to have a greater viscosity, resulting in an increase in the required pressure for processing the polymeric feedstock material, and a concomitant increase in viscous heating. Once the processed polymeric feedstock material is heated, the viscosity of the polymeric feedstock material is reduced, resulting in a stabilization of the temperatures and pressures of the polymeric feedstock material in the metering channels 4111, 4112, 4121, 4122, 4131, 4132 (e.g., at locations ranging from about 300 mm to 400 mm along the combined channel length).

Although the estimates of the temperatures of the processed polymeric feedstock material depicted in FIG. 10a and the estimates of changes in pressure for processing the polymeric feedstock material depicted in FIG. 10b appear to be similar to the corresponding estimates of the temperatures depicted in FIG. 9a and the corresponding estimates of changes in pressure depicted in FIG. 9b, respectively, there are differences in the respective temperature and pressure estimates due to the varying depths of the metering channels 4111, 4112, 4121, 4122, 4131, 4132. For example, upon close inspection of FIG. 10a, it can be observed that, for the metering channels with increased channel depths (such as the metering channel 4111 with the channel depth of 1.6 mm), the slope of the temperature trajectory is decreased (e.g., at locations ranging from about 150 mm to 250 mm along the combined channel length). Likewise, upon close inspection of FIG. 10b, it can be observed that, for the metering channels with increased channel depths (such as the metering channel 4111 with the channel depth of 1.6 mm), the slope of the changes in pressure trajectory is decreased (e.g., at locations ranging from about 150 mm to 250 mm along the combined channel length). Because the channels with increased channel depths tend to apply reduced shear stresses on the polymeric feedstock material being conveyed through the respective channels, the rates of temperature and pressure change for the processed polymeric feedstock material being conveyed through such channels likewise tend to be reduced.

An illustrative comparison of exemplary temperatures and pressures of the processed feedstock material at the outlets 1, 2, 3, 4, 5, 6 of the metering channels 4111, 4112, 4121, 4122, 4131, 4132, respectively, is provided in TABLE 3 below for the respective metering channels having a uniform channel depth (e.g., 1 mm) and varying channel depths (e.g., ranging from 1.1 mm to 1.6 mm).

TABLE 3

| | | |
|---|---|---|
| Channel | Uniform Depth | Varying Depth |

| Outlet | T (C.) | P (kPa) | T (C.) | P (kPa) |
|---|---|---|---|---|
| 1 | 53.4 | 375.5 | 53.1 | 364.8 |
| 2 | 53.3 | 373.8 | 53.0 | 364.7 |
| 3 | 53.2 | 371.7 | 53.0 | 364.6 |
| 4 | 53.0 | 369.7 | 52.9 | 364.4 |
| 5 | 52.9 | 367.4 | 52.8 | 363.8 |
| 6 | 52.8 | 365.0 | 52.7 | 363.2 |
| Mean | 53.10 | 370.50 | 52.91 | 364.25 |
| Standard deviation | 0.23 | 3.93 | 0.13 | 0.60 |

As indicated in TABLE 3, the temperatures corresponding to the outlets 1-6 of the metering channels with the varying channel depths ranging from 1.1 mm to 1.6 mm are lower than the temperatures corresponding to the outlets 1-6 of the metering channels with the uniform channel depth of 1 mm. Likewise, the pressures corresponding to the outlets 1-6 of the metering channels with the varying channel depths ranging from 1.1 mm to 1.6 mm are lower than the pressures corresponding to the outlets 1-6 of the metering channels with the uniform channel depth of 1 mm. Moreover, the standard deviations of the temperatures and the pressures corresponding to the outlets 1-6 of the metering channels with such varying channel depths are lower than the standard deviations of the temperatures and the pressures corresponding to the outlets 1-6 of the metering channels with such a uniform channel depth. By employing channels with varying channel depths (and/or varying channel widths) in an extrusion screw, it is possible to compensate for channel length differences that can adversely affect the temperatures and/or pressures of the feedstock material being conveyed through the respective channels.

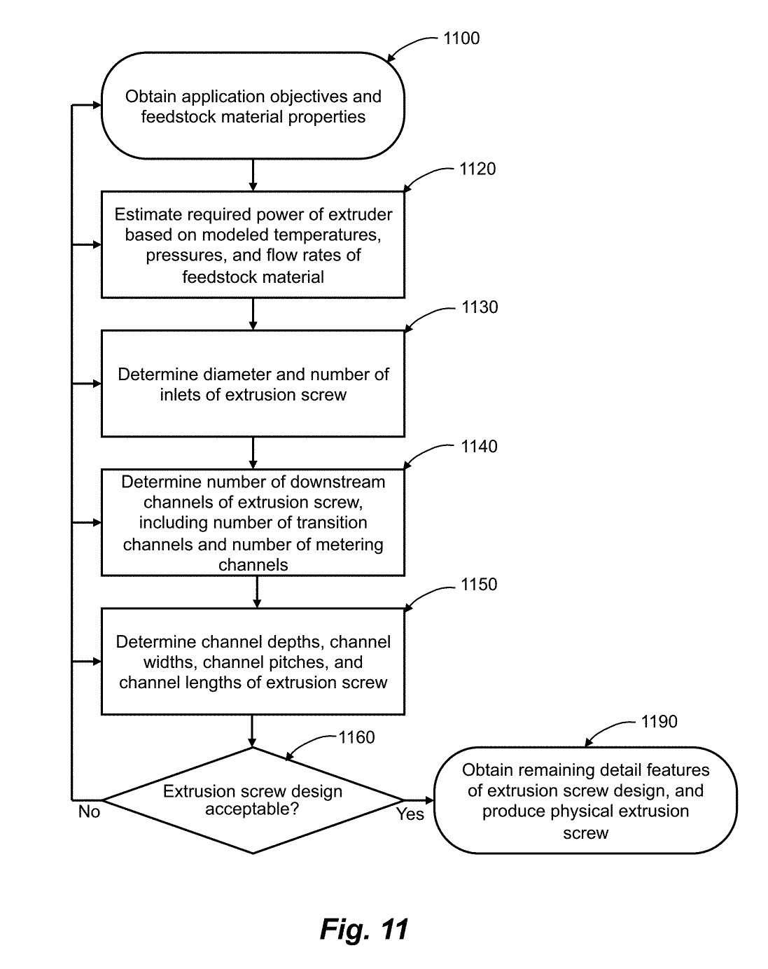

An illustrative method of designing an extrusion screw having multiple channels is described below with reference to FIG. 11. As depicted in block 1100, extrusion screw design objectives for a target application, as well as properties of feedstock material, are obtained. As depicted in block 1120, the required power of an extruder incorporating the extrusion screw design is estimated based on modeled temperatures, pressures, and flow rates of the feedstock material. As depicted in block 1130, the diameter and the number of inlets of the extrusion screw design are determined. It is noted that, in the event the diameter of the extruder barrel, as well as the diameter of the feed throat of the extruder, for the extrusion screw design are initially known, then block 1130 can be performed prior to block 1120. As depicted in block 1140, the number of downstream channels, including the number of transition channels and the number of metering channels of the extrusion screw design, are determined. As depicted in block 1150, the channel depths, the channel widths, the channel pitches, and the channel lengths of the extrusion screw design are determined. As depicted in block 1160, a determination is made as to whether or not the resulting extrusion screw design is acceptable. For example, the determination of block 1160 can involve one or more computational fluid dynamics analyses in two or three dimensions, as well as one or more of the model equations for determining the temperature, the viscous heating, the viscosity, the power, and/or the flow rate, as described herein. If the resulting extrusion screw design is unacceptable, then the method loops back to block 1100. Otherwise, if the resulting extrusion screw design is deemed to be acceptable, then the method proceeds to block 1190. As depicted in block 1190, the remaining detail features of the extrusion screw design (e.g., fillets, chamfers, fasteners) are determined, after which a physical extrusion screw is produced based on the accepted extrusion screw design.

With respect to the determination of the channel geometries, a change in the cross-sectional area of a channel of an extrusion screw can affect the compression, decompression, and/or conveyance of feedstock materials processed in the channel Such feedstock materials can have compressibility/decompressibility behaviors that are a function of certain physical states of the feedstock materials, such as the temperature, the pressure, the shear rate, etc.

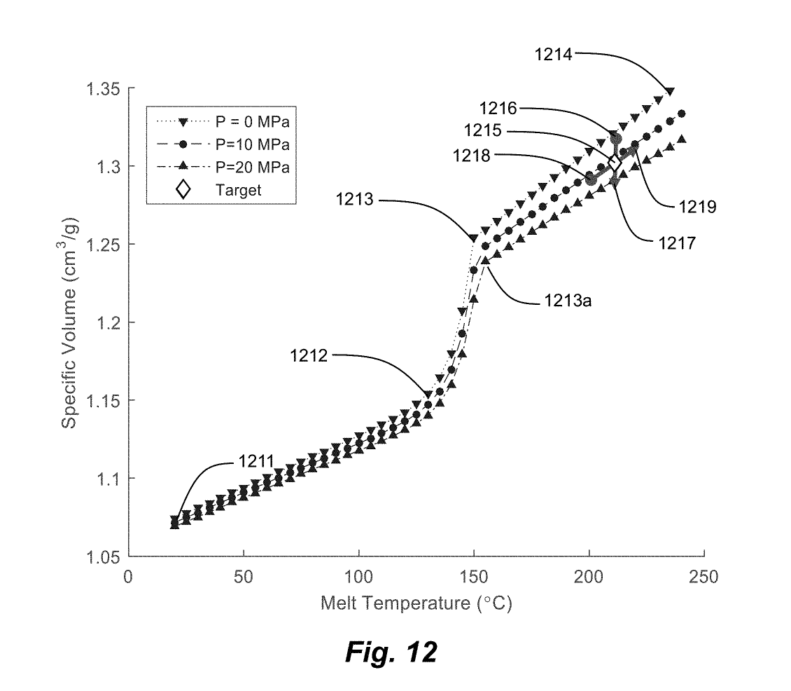

FIG. 12 depicts a graphical representation of exemplary estimates of specific volumes of a processed feedstock material as a function of melt temperature at three different processing pressures, namely, 0 MPa, 10 MPa, and 20 MPa. For example, the specific volume data provided in the graphical representation of FIG. 12 can be obtained using coefficients from the Autodesk/Moldflow database for a double domain Tait equation fit to specific volume data for Braskem H503, which is a grade of polypropylene with a melt flow index of 3.5 g/10 minutes. It is noted, however, that embodiments described herein can be derived using any other suitable constitutive models, or directly with empirical characterizations of the specific volume data as a function of temperature and pressure.

As shown in FIG. 12, the estimated specific volume at reference point 1211 is about 1.0743 cm³/g at a melt temperature of about 20° C., and the estimated specific volume at reference point 1214 is about 1.3484 cm³/g at a melt temperature of about 235° C. With reference to FIG. 12, it can be observed that the specific volume of the processed feedstock material increases with the melt temperature of the feedstock material. With increasing melt temperature, the feedstock material begins to change its phase from a semi-crystalline solid at reference point 1212 to an amorphous melt at reference point 1213. This phase change of the feedstock material causes an expansion of the volume occupied by the molecules of the feedstock material, and, concomitantly, an increase in the specific volume. As illustrated by the shift in the melt temperature from reference point 1213 (0 MPa) to reference point 1213a (20 MPa), the transition temperature from the solid state to the melt state is a function of the pressure of the feedstock material.

It is noted that the coefficient of volumetric thermal expansion (also referred to herein for convenience as “alpha”) and compressibility (also referred to herein for convenience as “beta”) of a feedstock material are typically greater for the feedstock material in its melt state than in its solid state. With reference to FIG. 12, both alpha and beta can be determined at a target reference point 1215, using nearby specific volume data. More specifically, the target reference point 1215 can correspond to a melt temperature of about 211° C. and a melt pressure of about 12 MPa. Further, nearby reference points 1216 and 1217 can correspond to the same melt temperature of 211° C. but different melt pressures of 4 MPa and 20 MPa, respectively, and nearby reference points 1218 and 1219 can correspond to the same melt pressure of 12 MPa but different melt temperatures of 202° C. and 220° C., respectively. The melt temperatures (T), melt pressures (P), and specific volumes (v) at reference points 1215, 1216, 1217, 1218, 1219, which are representative of typical extrusion processing conditions for the feedstock material, are provided in TABLE 4 below.

TABLE 4

| Reference | Melt | Melt | Specific |
|---|---|---|---|
| Point | Temperature, T | Pressure, P | Volume, v |
| 1215 | 211° C. | 12 MPa | 1.3023 cm³/g |
| 1216 | 211° C. | 4 MPa | 1.3149 cm³/g |
| 1217 | 211° C. | 20 MPa | 1.2909 cm³/g |
| 1218 | 202° C. | 12 MPa | 1.2935 cm³/g |
| 1219 | 220° C. | 12 MPa | 1.3110 cm³/g |

For purposes of illustration, the variables v, P, and T are employed herein to designate the specific volume, the melt pressure, and the melt temperature, respectively, of the feedstock material, and subscripts for the respective variables v, P, and T (if any) correspond to nearby reference points 1216, 1217, 1218, 1219, which are indicative of the state of the feedstock material. Further, alpha (i.e., the feedstock material's coefficient of volumetric thermal expansion) is defined herein as the derivative of the specific volume with respect to temperature at constant pressure. Accordingly, with reference to FIG. 12, alpha can be calculated, using a central difference method, as follows:

alpha=(v₁₂₁₉−v₁₂₁₈)/(T₁₂₁₉−T₁₂₁₈). (7)

Substituting the values provided in Table 4 into equation (7), alpha can be expressed as follows:

alpha=(1.3110−1.2935)/(220° C.−202° C.),

alpha=9.7303.10⁻⁴/° C.

Beta (i.e., the feedstock material's compressibility) is defined herein as the negative of the derivative of the specific volume with respect to pressure at constant temperature. Accordingly, with reference to FIG. 12, beta can be calculated, using the central difference method, as follows:

beta=−(v₁₂₁₇−v₁₂₁₆)/(P₁₂₁₇−P₁₂₁₆). (8)

Substituting the values provided in Table 4 into equation (8), beta can be expressed as follows:

beta=(1.2909−1.3149)/(20 MPa−4 MPa),

beta=1.5002.10⁻³/MPa.

It is noted that the values in TABLE 4 are provided for purposes of illustration. Further, alpha and beta can be calculated for any target reference point using any suitable numerical technique, including, but not limited to, the central difference method, a backward difference method, a forward difference method, a regression technique, as well as analytical derivatives of constitutive models fit to material characterization data.

The specific volume behavior, i.e., the relatively similar values of alpha and beta with respect to operating temperatures per ° C. and operating pressures per MPa, can be beneficially used to control the melt temperature and the melt pressure of a feedstock material as it is being processed. Specifically, the size of the channels of an extrusion screw can be varied in order to provide a positive change in volumetric expansion and associated reduction in pressure, thereby reducing or maintaining the feedstock material temperature in the presence of continued internal shear heating. It is noted that the relationship between pressure and temperature can be directly determined by application of the chain rule from calculus. Because alpha is the derivative of specific volume with respect to temperature, and beta is the derivative of specific volume with respect to pressure, the derivative of temperature with respect to pressure can be obtained as follows:

beta/alpha=−(dv/dP)/(dv/dT),

beta/alpha=−dT/dP. (9)

Accordingly, for the data illustrated in FIG. 12, the derivative of temperature with respect to pressure can be obtained as follows:

dT/dP=(1.5002·10⁻³/MPa)/(9.7303·10⁻⁴/° C.),

dT/dP=1.535° C./MPa. (10)

In practice, the relative changes in the size of a channel of an extrusion screw, and concurrent changes in feedstock material temperature and pressure, can be dependent on a feedstock material's properties, extrusion processing conditions, and/or design objectives. For example, a particular design objective can be to maintain a consistent feedstock material temperature and pressure by enlarging the size of the channel in order to compensate for internal shear heating during processing of the feedstock material. The magnitude of internal shear heating can be estimated as the product of the apparent viscosity and the square of the apparent shear rate of the feedstock material in the channel. The total temperature increase due to internal shear heating can then be computed relative of the flow rate and the mass of the feedstock material being processed. Further, the geometry of one or more channels of the extrusion screw can be selected in order to control the temperature and the pressure of the feedstock material being processed.

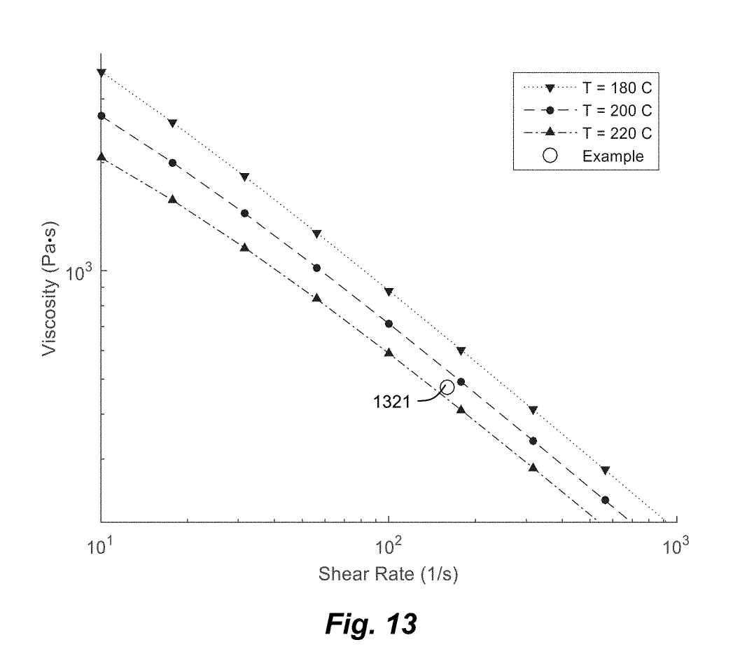

Feedstock materials that undergo processing by extruders can have viscosity behaviors that are a function of certain physical states of the feedstock materials, such as the temperature, the pressure, the shear rate, etc. FIG. 13 depicts a graphical representation of an exemplary apparent viscosity of a feedstock material being processed as a function of shear rate at three different processing temperatures, namely, 180° C., 200° C., and 220° C. For example, the viscosity data of FIG. 13 can be calculated using coefficients from the Autodesk/Moldflow database for a Cross-WLF model fit to apparent viscosity data for Braskem H503. It is noted, however, that embodiments described herein can be derived using any other suitable constitutive models, or directly with empirical characterizations of the apparent viscosity as a function of temperature, shear rate, and, optionally, pressure.

As shown in FIG. 13, the apparent viscosity decreases with the temperature and the shear rate of the feedstock material being processed. It is noted that the apparent viscosity is plotted in FIG. 13 using log-log axis scaling, and therefore small changes in the temperature and/or the shear rate can have significant effects on the magnitude of the apparent viscosity. With regard to FIG. 13, reference point 1321 represents an apparent viscosity of 476 Pa·s for the feedstock material being processed at a temperature of 211° C. and a shear rate of 160 l/s.

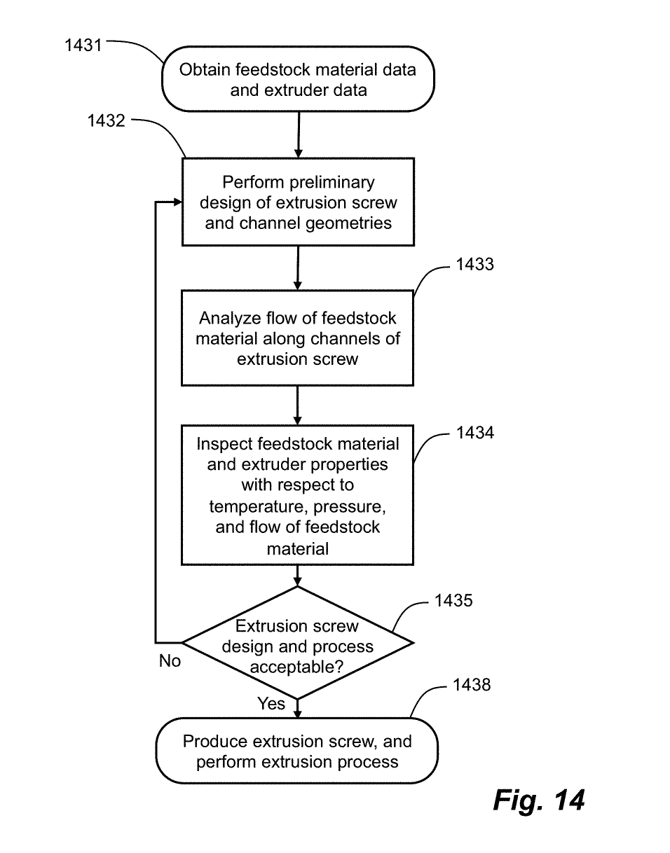

A further illustrative method of designing an extrusion screw is described below with reference to FIG. 14. As depicted in block 1431, feedstock material data and extruder data are obtained. For example, the feedstock material data can include the compressibility behavior (such as the compressibility behavior illustrated in FIG. 12) of the feedstock material, the viscosity behavior (such as the viscosity behavior illustrated in FIG. 13) of the feedstock material, and the thermal properties (e.g., the density, the specific heat, the thermal conductivity) of the feedstock material. The extruder data can include the materials used to produce the extrusion screw, the extruder barrel, and/or other components of the extruder. The extruder data can further include the diameter and the length of the extruder barrel, specifications related to the extruder motor speed and torque, the desired temperature and mass flow rate of the extrudate, and, optionally, the pressure and the geometry of the extrusion die.

As depicted in block 1432, having obtained the feedstock material data and the extruder data, a preliminary design of the extrusion screw including its channel geometries is performed, thereby obtaining a set of extrusion screw design parameters such as the number of channels, the screw diameter, the screw length, the channel width, the channel pitch, the flight width, and the number of channel rotations about the extrusion screw, etc. For example, given a predetermined extrusion screw diameter, D, the extrusion screw can be designed with a length of 20×D, a single channel having a single flight, a channel pitch equal to D, a channel width equal to 0.9×D, a feed channel depth equal to 0.2×D, and a metering channel depth equal to 0.1×D. It is noted that such a set of extrusion screw design parameters are provided for purposes of illustration, and any other suitable set of extrusion screw design parameters can be employed.

As depicted in block 1433, having obtained the preliminary extrusion screw design parameters, the flow of the feedstock material along the channel(s) of the extrusion screw is analyzed. It is noted that the feedstock material being processed can undergo significant changes during its conversion from feedstock material to extrudate. For an accurate analysis of the flow of feedstock material, the geometry of the channel(s) of the extrusion screw can be discretized into smaller portions, each of which can be analyzed. Any suitable analytical, numerical, and/or experimental technique can be employed in order to obtain an understanding of the temperature, the flow, and the pressure of the feedstock material being processed. Alternatively, a physical extrusion screw can be produced in accordance with the preliminary extrusion screw design parameters, and subsequently operated in accordance with the extruder data, in order to analyze the flow of the feedstock material along the channels of the extrusion screw.

As depicted in block 1434, having obtained an understanding of the temperature, the flow, and the pressure of the feedstock material being processed, the properties of the feedstock material and the extruder are inspected to determine whether the temperature, the flow, and the pressure of the processed feedstock material are within desired processing ranges, as well as whether the extruder motor speed and torque required to achieve an acceptable processing of the feedstock material are within the specification of the extruder. Any suitable analytical models and/or numerical simulations can be employed in order to predict such inspection results. Alternatively, such inspection results can be obtained by implementing and operating a physical extruder system. Such a physical extruder system can be suitably instrumented to monitor the value and the consistency of the temperature, the flow, and the pressure of the feedstock material being processed. The extrusion screw included in such a physical extruder system can also be inspected in order to check the melting rates and/or degradation of the feedstock material being processed.

As depicted in block 1435, a determination is made as to whether or not the extrusion screw design, as well as the overall extrusion process involving the flow of feedstock material along the channels of the extrusion screw, are acceptable. If the extrusion screw design and the extrusion process are unacceptable, then the method loops back to block 1432 where the extrusion screw design can be modified to implement any required changes. For example, such changes can be made by computer automation using iterative design and analysis techniques in order to optimize an objective function. Further, in order to achieve certain extrusion outcomes, the properties of the feedstock material being processed, and/or other extruder properties or extrusion processing conditions (as previously specified at block 1431) such as the extrusion screw diameter, the extrusion screw length, the extruder motor speed, and/or any other suitable feedstock material or extruder properties, can be changed. Otherwise, if the extrusion screw design and the extrusion process are deemed to be acceptable, then the method proceeds to block 1438. As depicted in block 1438, a physical extrusion screw is produced based on the accepted extrusion screw design, and an extrusion process conforming to the accepted extrusion process is performed.

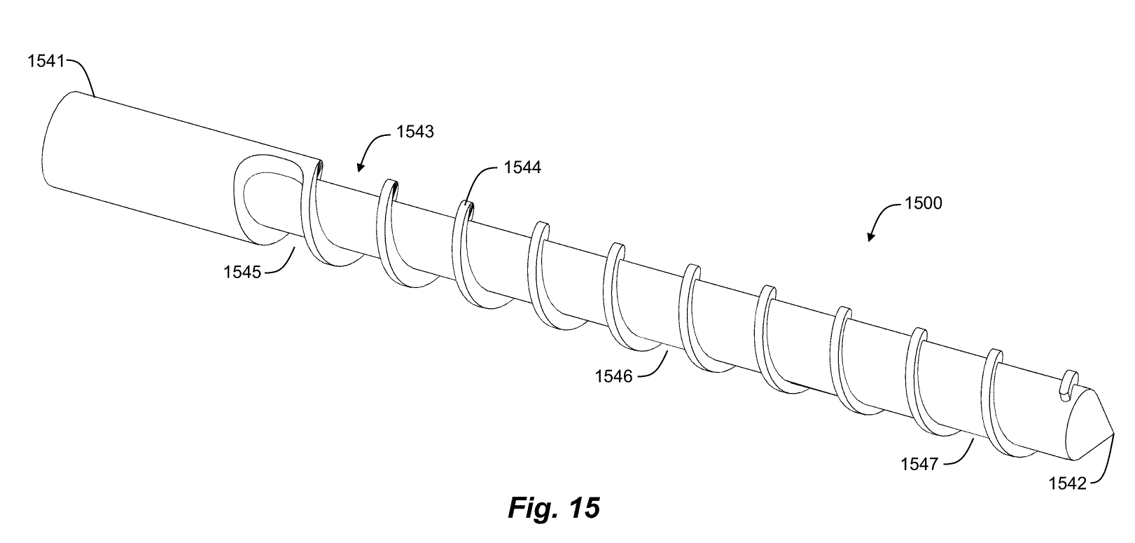

FIG. 15 depicts a perspective view of an illustrative embodiment of an exemplary extrusion screw 1500. As shown in FIG. 15, the extrusion screw 1500 includes a proximal end 1541, a distal end 1542, a single helical channel 1543, and a single flight 1544. The extrusion screw 1500 further includes a plurality of processing zones, including a feed zone indicated generally by reference numeral 1545, a transition zone indicated generally by reference numeral 1546, and a metering zone indicated generally by reference numeral 1547. For example, the extrusion screw 1500 can have an outer diameter of 20 mm, or any other suitable outer diameter. Feedstock material to be processed by the extrusion screw 1500 can enter through the feed throat of a hopper (not shown) of an extruder. Such a feed throat is typically located above the proximal end 1541 of the extrusion screw 1500. Further, the feed zone 1545 can encompass the first two (2) turns of the helical channel 1534, the transition zone 1546 can encompass the next six (6) turns of the helical channel 1534, and the metering zone 1547 can encompass the final three (3) turns of the helical channel 1534. It is noted that the design parameters of the extrusion screw 1500, including the size of the extrusion screw 1500, the number of turns of the helical channel 1543, the relative lengths of the feed, transition, and metering zones 1545, 1546, 1547, the relative channel sizes in the various processing zones, and/or the numbers of flights and/or channels, are provided for purposes of illustration, and that any other suitable screw design parameters can be employed.

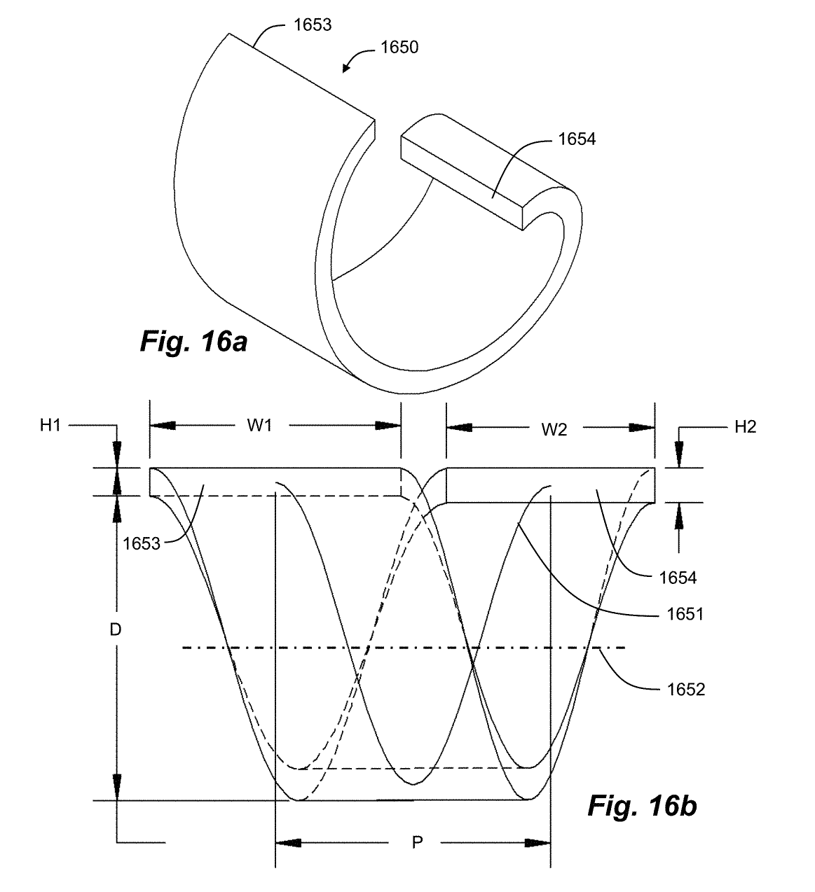

FIG. 16a depicts a section 1650 of the channel 1543 of the extrusion screw 1500 shown in FIG. 15. FIG. 16b depicts an exemplary geometric definition of the section 1650 of the channel 1543, in accordance with a curved centerline 1651 having a radius, R, about a screw centerline 1652, a mean channel pitch, P, and a number of rotations, n (e.g., 1), about the extrusion screw 1500. The channel length (i.e., the arc length), L, for the section 1650 of the channel 1543 can be approximated as follows:

L=n\sqrt{(2πR)²+P²}. (11)

If channel sections (such as the section 1650) of the extrusion screw 1500 (see FIG. 15) vary as a function of the curved centerline 1651, then the arc length, L, of the curved centerline 1651 can vary. It is noted that the mean (or average) radius, R, and the mean (or average) channel pitch, P, can be used in equation (11) because the radius, R, and the channel pitch, P, of the section 1650 can vary in the target application. It is further noted that other determinations of the arc length, L, can be obtained through calculus or by inspection of three dimensional models implemented via computer-aided design techniques. Moreover, other centerline geometries and/or dimensions can be readily implemented in practice. For example, the curved centerline 1651 can be formed by a variable pitch and a variable diameter helix, and the channel can be formed by sweeps and lofts defined by multiple sections and/or arbitrary paths.

As shown in FIG. 16b, the section 1650 of the channel 1543 of the extrusion screw 1500 has an outer diameter, D (e.g., 20 mm) and a channel pitch, P (e.g., 18 mm). Further, an upstream portion 1653 of the section 1650 has a depth, H1 (e.g., 1.8 mm) and a width, W1 (e.g., 16.4 mm), while a downstream portion 1654 of the section 1650 has a depth, H2 (e.g., 2.2 mm) and a width, W2 (e.g., 13.6 mm). It is noted that the specific dimensions of the upstream and downstream portions 1653, 1654 of the section 1650 are provided for purposes of illustration, and that any other suitable dimensions and/or geometries for the channel section can be employed, such as rectangular, triangular, ellipsoidal, rounded, and/or any other suitable straight and/or curved section geometries. It is further noted that the downstream portion 1654 is illustrated as having a larger cross-sectional area than that of the upstream portion 1653, and can therefore provide for a decompression of the feedstock material being processed. Alternatively, the upstream portion 1653 can have a cross-sectional area that is larger than that of the downstream portion 1654, thereby providing for a compression of the feedstock material being processed. Having provided the exemplary geometric definition of the section 1650 of the channel 1543, as illustrated in FIGS. 16a and 16b, the feedstock material being processed in the section 1650 can have a mean radius, R, of 9 mm, and a centerline length of about 59 mm.

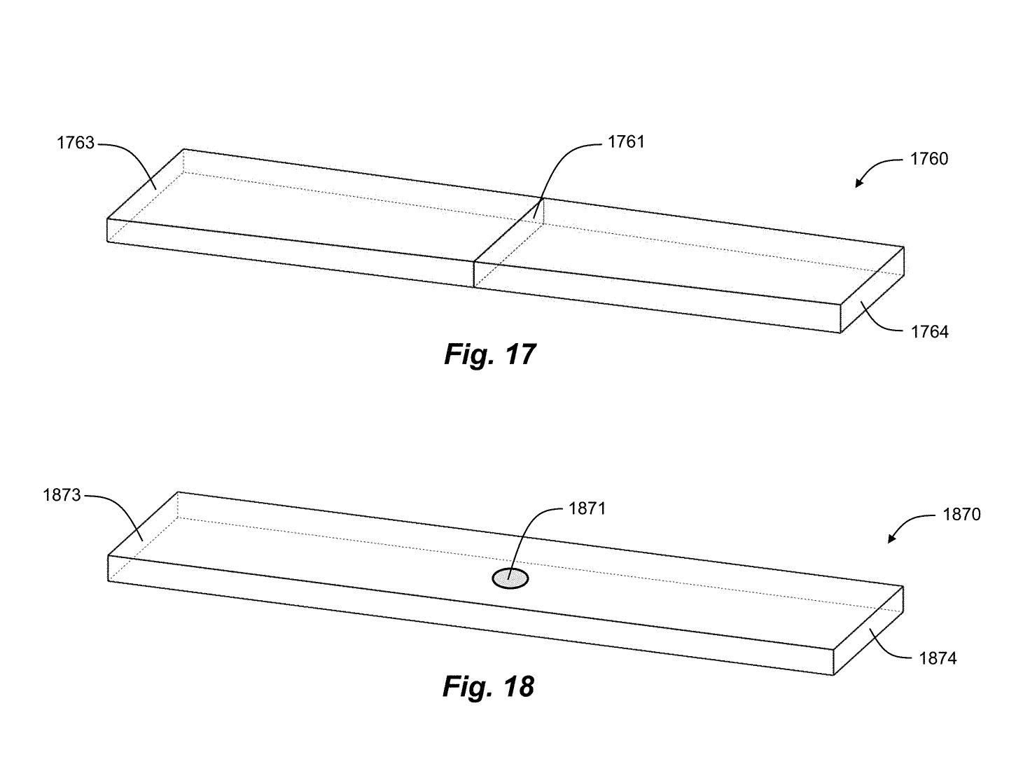

FIG. 17 depicts an exemplary prismatic geometry 1760, which can be used to model the section 1650 (see FIG. 16a) of the channel 1543 of the extrusion screw 1500 (see FIG. 15). As shown in FIG. 17, the geometry of the section 1650 can conceptually be laid flat or unrolled in order to facilitate the modeling of the section 1650. With reference to FIGS. 16a, 16b, and 17, the upstream portion 1653 of the section 1650 having width W1 and depth H1 corresponds to an upstream portion 1763 of the prismatic geometry 1760, and the downstream portion 1654 of the section 1650 having width W2 and depth H2 corresponds to a downstream portion 1764 of the prismatic geometry 1760.

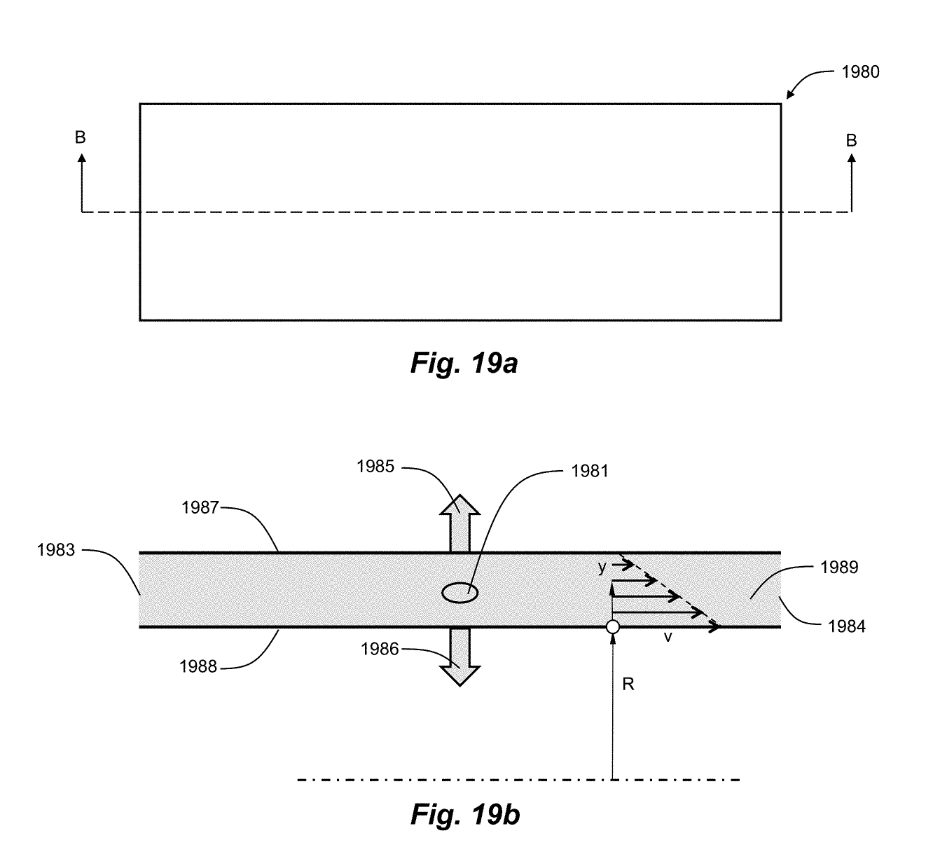

To facilitate the modeling of the section 1650 of the channel 1543 of the extrusion screw 1500, the prismatic geometry 1760 (see FIG. 17) can be configured as a rectangular cuboid 1870 (see FIG. 18), in which a mid-section 1761 of the prismatic geometry 1760 has a length, L, an average width, W, equal to one-half of the sum of W1 and W2 (e.g., 2 mm), and an average depth, H, equal to one-half of the sum of H1 and H2 (e.g., 15 mm). FIG. 18 depicts the rectangular cuboid 1870 having an upstream portion 1873 and a downstream portion 1874, and a representation of processed feedstock material (corresponding to reference numeral 1871). It is noted that the channel 1543 of the extrusion screw 1500 can be discretized and defined by a geometry composed of a plurality of such rectangular cuboids and/or other finite elements, which can be analytically and/or numerically modeled. It is further noted that the modeling of the section 1650 of the channel 1543 of the extrusion screw 1500 with the prismatic geometry 1760 can be performed using any suitable one-dimensional, two-dimensional, or three-dimensional simulation technique.

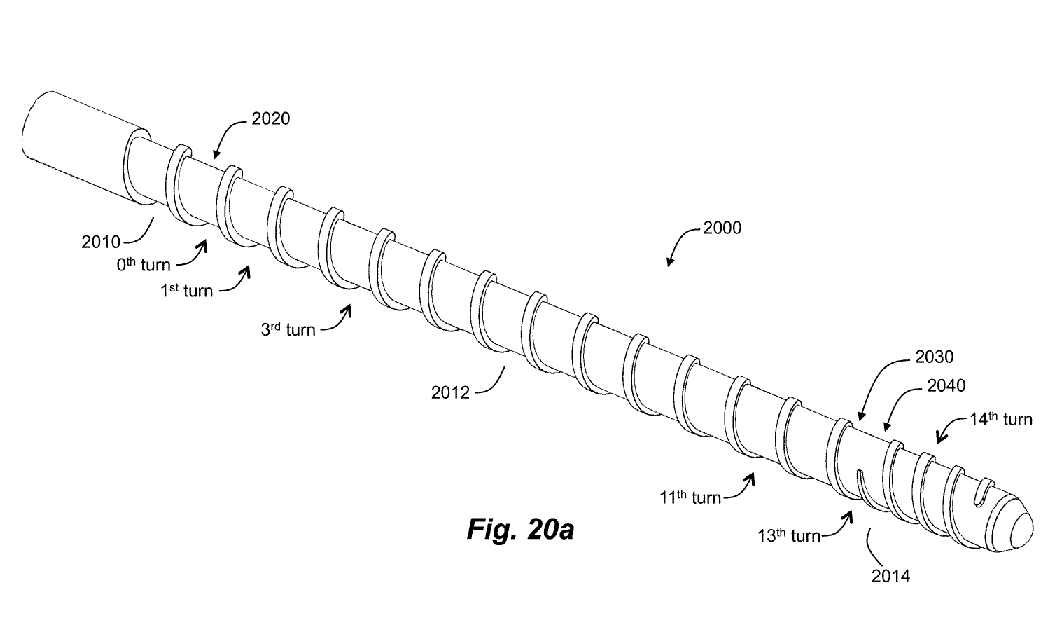

FIG. 19a depicts a top view 1980 of the rectangular cuboid 1870 (see FIG. 18) defined by the prismatic geometry 1760 (see FIG. 17) having the mid-section 1761 with the length, L, the average width, W, and the average depth, H. FIG. 19b depicts a cross-sectional view of the rectangular cuboid 1870 through a cross-section B-B (see FIG. 19a). With reference to FIG. 19b, the pressure, P, and the flow rate, Q, at an upstream portion 1983 and at a downstream portion 1984 can be determined by an inspection of an existing extrusion process, or by estimation based on a solution of the channel geometry in accordance with predetermined boundary conditions. A top surface 1987 of the rectangular cuboid 1870 corresponds to an outer surface of feedstock material 1981 being processed in the section 1650 of the channel 1543 of the extrusion screw 1500. It is noted that the outer surface of the processed feedstock material 1981 is bounded by the bore of the extruder barrel, and is therefore generally considered to be stationary. A bottom surface 1988 of the rectangular cuboid corresponds to an inner surface of the feedstock material 1981 being processed in the section 1650 of the channel 1543 of the extrusion screw 1500. It is noted that the inner surface of the processed feedstock material 1981 is bounded by the outer surface of the extruder screw, and is therefore generally rotating.

The radial velocity, vᵣ, tangential to a location on the extrusion screw 1500, can be expressed as follows:

vᵣ=πd·RPM, (12)

in which “d” corresponds to the diameter of the extrusion screw 1500 at the bottom of the channel 1543, and “RPM” corresponds to the number of rotations per minute of the extrusion screw 1500. The processed feedstock material's velocity, v, in the direction of the distal end 1542 of the extrusion screw 1500 can therefore be expressed as follows:

v=πd·RPM·cos ϕ, (13)

in which “ϕ” corresponds to a helix angle of the helical channel 1543, as follows:

$$φ = {tan}^{- 1} \frac{P}{π d} , \qquad ( 14 )$$

and “P” corresponds to the channel pitch.

Equations (13) and (14) can be used to analyze the velocity of processed feedstock material flowing through a rectangular section of the channel 1543 along a helical curve about the extrusion screw 1500. Such an analysis can be performed by modeling the channel 1543 of the extrusion screw 1500 as a plurality of discrete sections (such as the section 1650), and calculating the angle of the normal to the surface of the channel's flight 1544 relative to the radial direction of the extrusion screw 1500. The downstream velocity, v(y), of the feedstock material flowing in the channel 1543 can be estimated as a function of distance in the depth direction, y, as follows:

$$v ( y ) = ( \frac{v}{H} - \frac{dP / dLH}{2 μ} ) y + \frac{dP / dL}{2 μ} {y}^{2} \qquad ( 15 )$$

in which “dP/dL” corresponds to the derivative of the pressure, P, of the processed feedstock material with respect to distance in the length direction, L, of the extrusion screw 1500, and “μ.” corresponds to the apparent viscosity of the feedstock material being processed. The shear rate, s(y), of the processed feedstock material as a function of distance in the depth direction, y, can be expressed as the derivative of the downstream velocity, v(y), with respect to distance in the depth direction, y, as follows:

$$s ( y ) = \frac{dv}{dy} = \frac{v}{H} - \frac{dP / dLH}{2 μ} + \frac{dP / dL}{2 μ} y . \qquad ( 16 )$$

The shear rate, s(y), in an extrusion process is typically dominated by the flow of feedstock material associated with the downstream velocity (v), resulting from the rotation of the extrusion screw. As indicated in equation (16), the shear rate, s(y), can be represented by the term, v/H, in which “H” corresponds to the average depth of the prismatic geometry 1760 (see FIG. 17). It is noted, however, that the shear rate, s(y), can also be expressed in terms of the pressure gradient (dP) with respect to distance in the length direction (dL) of the extrusion screw, as further indicated in equation (16).

It is further noted that, in an extrusion process, the rate of viscous heat generation can be estimated as a product of the viscosity, the square of the shear rate, and the volume of processed feedstock material. Moreover, the total energy generated by viscous heating can be determined as the product of the rate of viscous heat generation and the time duration, dt, during which the feedstock material is being viscously heated. In addition, the change in temperature can be determined as the total heat generated by such viscous heating, divided by the product of the mass, m, and the specific heat, C_{P}. For a feedstock material having a finite mass being processed in a channel having a length, L, a width, W, and a depth, H, the volume of the processed feedstock material can be determined as the product of the channel length, L, the channel width, W, and the channel depth, H, and the mass can be determined as the product of the volume and the density of the processed feedstock material. Accordingly, with the time duration, dt, being estimated as the channel length, L, divided by the downstream velocity, v, of the feedstock material flowing in the channel, the change in the bulk temperature, dT, of the processed feedstock material can be expressed as follows:

$$dT = \frac{μ {s}^{2} ( LWH ) Δ t}{ρ ( LWH ) {C}_{P}} = \frac{μ {s}^{2} L}{ρ v {C}_{P}} . \qquad ( 17 )$$

Equation (17) can be used to provide an estimate of the change in temperature of a processed feedstock material as a function of shear heating. For example, consider the extrusion screw 1500 having the section 1650 of the helical channel 1543, in which the section 1650 is disposed in the metering zone 1547 of the extrusion screw 1500 and modeled as the rectangular cuboid 1870. Further, assume that the extrusion screw 1500 has an outer diameter of 20 mm, the section 1650 has a channel depth of 2 mm, and the helix angle is 17.7 degrees relative to the curved centerline 1651. It is noted that the base of the channel 1543 can be located at a different radial location relative to the screw centerline 1652. Assuming that the base of the channel 1543 is located at a distance of 8 mm from the screw centerline 1652, the helix angle can be more accurately determined to be equal to 19.7 degrees relative to the curved centerline 1651.

In addition, assume that the section 1650 of the channel 1543 of the extrusion screw 1500 modeled as the rectangular cuboid 1870 is employed in an extrusion process, in which the extrusion screw 1500 rotates at a predetermined RPM. In this case, the downstream velocity, v, of the processed feedstock material near the base of the channel 1543 can be 19,200 mm/minute (or 319 mm/s). Further, for a channel depth of 2 mm, the apparent shear rate can be 160 l/s, and the time for the feedstock material to traverse the length of the section 1650 can be 0.19 s. Further, given a target melt temperature of 211° C. and a target melt pressure of 12 MPa, the apparent viscosity can be 476 Pa·s and the specific volume, sv1, at the section 1650 can be 1.3023 cm³/g, which corresponds to a density of 767.8 kg/m³.

If the specific heat is 2800 J/kg° C., then the temperature change, dT (see equation (17)), of the feedstock material being processed in the section 1650 of the channel 1543 of the extrusion screw 1500 can be estimated to be 1.05° C., not taking into account decompression due to the expansion of the channel volume. Such a temperature change, dT, can cause thermal expansion of the feedstock material in the section 1650, as well as a concurrent pressure (P) increase, which can be estimated as the product of the temperature change, dT, and dP/dT, as follows:

dT×dP/dT=1.05° C.×1.535° C./MPa=1.61 MPa.

The effect of such a temperature change and pressure increase can be significant, given that the estimated temperature change, dT, and the concurrent pressure (P) increase correspond to the relatively small discrete section 1650 of the channel 1543. It is noted that the effects of internal viscous heating can be much larger for longer channels, increased screw speeds, and channels with reduced depths. It is further noted that, in the foregoing example, the specific heat is considered to be constant for purposes of illustration. However, the specific heat, as well as the thermal conductivity, the density, and/or other properties of the processed feedstock material can vary as a function of temperature and/or other states of the feedstock material, and can be modeled through numerical analysis.

Extrusion screws and extrusion processes can be designed taking into account temperature changes and pressure changes as a function of internal shear heating and compressibility of a feedstock material. For example, a channel of an extrusion screw can be tapered in order to control both the temperature and the pressure of the feedstock material being processed. With reference to FIGS. 15, 16a, and 16b, the geometry of the section 1650 of the channel 1543 of the extrusion screw 1500 can have the upstream portion 1653 with a cross-sectional area (i.e., A1=W1*H1) equal to 29.52 mm², and the downstream portion 1654 with a cross-sectional area (A2=W2*H2) equal to 29.92 mm². The compression ratio, CR (i.e., the change in the cross-sectional area (A1) of the downstream portion 1654 relative to the cross-sectional area (A2) of the upstream portion 1653) can be defined as follows:

CR=A1/A2, (18)

and therefore the compression ratio, CR, for this example can be equal to 0.9866. Because this compression ratio, CR, is less than 1, the feedstock material being processed can be decompressed as it flows through the section 1650 of the channel 1543. If the pressure is maintained across the section 1650 of the channel 1543, then the specific volume (sv2) at the downstream portion 1654 can be determined as the product of the specific volume (sv1) at the upstream portion 1653 and the compression ratio (CR), as follows:

sv2=sv1×CR=1.3023×0.9866=1.285.

The temperature change, dT, of the feedstock material being processed in the section 1650 of the channel 1543 of the extrusion screw 1500 due to such decompression of the feedstock material can be expressed as follows:

$$dT = \frac{sv 2 - sv 1}{dq / dT} . \qquad ( 19 )$$

Accordingly, substituting the values for the specific volume (sv2) at the downstream portion 1654 and the specific volume (sv1) at the upstream portion 1653 into equation (19), the resulting decrease in temperature due to the decompression of the feedstock material can be estimated to be 17.9° C.

It is noted that estimates can also be obtained for temperature changes due to heat transfer between the processed feedstock material, the extruder barrel, and/or the extrusion screw, assuming that the feedstock material, the extruder barrel, and/or the extrusion screw are at different temperatures. In some extrusion processes, the proximal end 1541 of the extrusion screw 1500 can be actively cooled via an internal coolant hole to an initial temperature, T1. If the temperature of the distal end 1542 of the extrusion screw 1500 is T2, then, by Fourier's law of conduction, the rate of energy transfer, dE/dt, due to thermal conduction along the length of the extrusion screw 1500 can be expressed as follows:

$$\frac{dE}{dt} = k ( T 2 - T 1 ) \frac{π {R}^{2}}{L} . \qquad ( 20 )$$

For example, assume that the extrusion screw 1500 has an outer diameter of 20 mm and a length of 250 mm, and is made of stainless steel with a heat conduction coefficient, k, of 24.9 W/m. If the initial temperature, T1, of the proximal end 1541 of the extrusion screw 1500 is 41° C., and the temperature, T2, of the distal end 1542 of the extrusion screw 1500 is 211° C., then, using equation (20), the rate of energy transfer, dE/dt, due to thermal conduction along the length of the extrusion screw 1500 can be estimated to be about 531 W.

The rate of energy transfer, dE/dt, in the radial direction of the extrusion screw 1500 can also be obtained by Fourier's law of conduction, as follows:

$$\frac{dE}{dt} = h ( T 4 - T 3 ) , \qquad ( 21 )$$

in which “h” corresponds to the heat transfer coefficient associated with an external heater for the extruder barrel, forced fan convection, or free convention to the environment, and “T3” and “T4” correspond to the temperature of the outer surface of the extruder barrel and a reference control temperature, respectively. Such a heat transfer coefficient, h, can also be employed for modeling the heat transfer within the extrusion process, such as, for example, at the extruder barrel-feedstock material melt interface or the extrusion screw-feedstock material melt interface. It is noted that such modeling of the heat transfer within extruder processes can be performed by one-dimensional, two-dimensional, or three-dimensional computerized analyses, as well as by inspection of physical, instrumented extrusion processes.

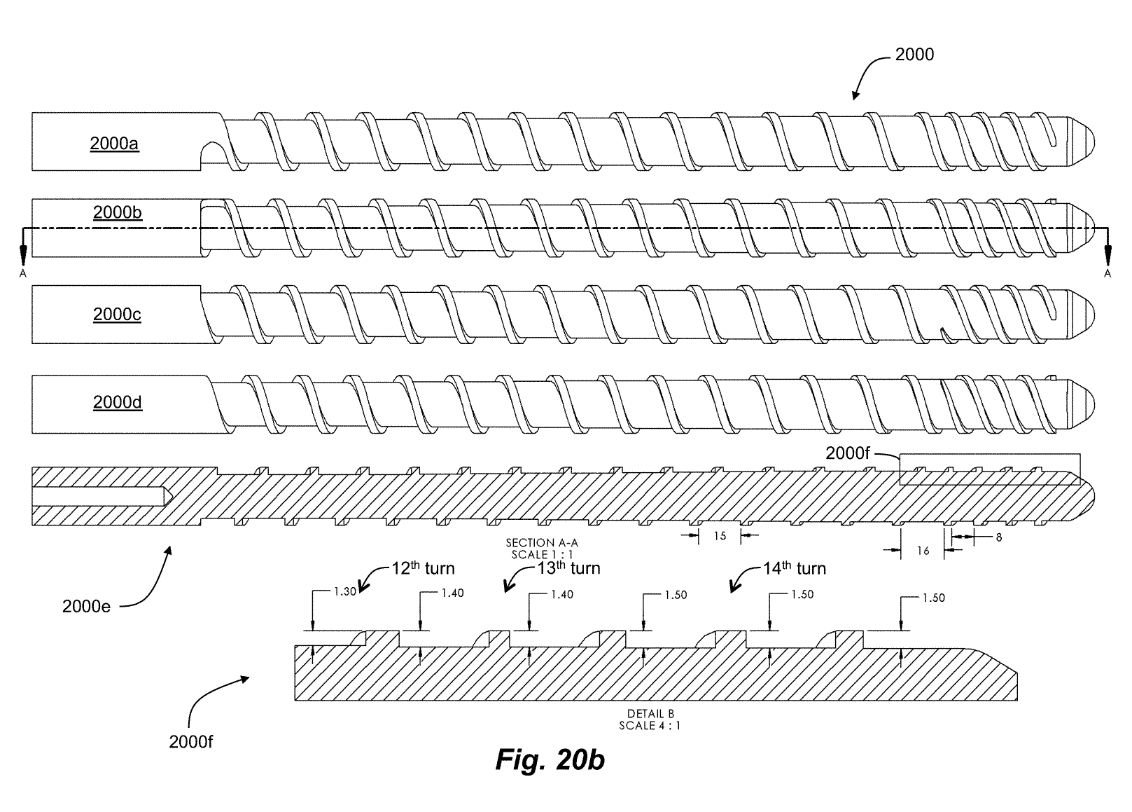

FIG. 20a depicts a perspective view of an illustrative embodiment of an exemplary extrusion screw 2000, which includes a feed zone indicated generally by reference numeral 2010, a transition zone indicated generally by reference numeral 2012, and a metering zone indicated generally by reference numeral 2014. As shown in FIG. 20a, the extrusion screw 2000 includes a helical channel 2020 that extends from the feed zone 2010 through the transition zone 2012, and divides into two channels 2030, 2040 in the metering zone 2014. FIG. 20b depicts several orthogonal views 2000a, 2000b, 2000c, 2000d of the extrusion screw 2000, as well as a cross-sectional view 2000e across a cross-section A-A and a detail view 2000f of the extrusion screw 2000. With reference to the extrusion screw 2000 of FIGS. 20a and 20b, the combined widths and depths of the channels (i.e., the channels 2030, 2040; see FIG. 20a) in the metering zone 2014 (see also FIG. 20a) can be increased based on the target application and/or design objectives.

For purposes of illustration, exemplary design parameters are provided for the extrusion screw 1500 having the single channel 1543 (see FIG. 15) in TABLE 5 below.

TABLE 5
Design of FIG. 15

| Turn | Flight Pitch | Channel Depth | # Channels | Channel Width |
|---|---|---|---|---|
| 0 | 18 | 4 | 1 | 15 |
| 4 | 18 | 4 | 1 | 15 |
| 15 | 18 | 2 | 1 | 15 |
| 19 | 18 | 2 | 1 | 15 |

With reference to TABLE 5, it is indicated that, from the 0^{th} turn up to (but not including) the 15^{th} turn of the single channel 1543 of the extrusion screw 1500, the channel depth is 4 mm (e.g., 20% of the diameter of the extrusion screw 1500), the channel width is 15 mm, and the flight pitch is 18 mm. At the 15^{th} turn of the single channel 1543 (i.e., at the start of the metering zone 1547), the channel depth is reduced from 4 mm to 2 mm. Further, the channel depth is maintained at 2 mm from the 15^{th} turn up to (and including) the 19^{th} turn of the single channel 1543 in the metering zone 1547.

Exemplary design parameters are also provided for the extrusion screw 2000 (see FIGS. 20a and 20b) having multiple channels in TABLE 6 below, in which the combined widths and depths of the respective channels (e.g., the channels 2030, 2040; see FIG. 20a) in the metering zone 2014 (see also FIG. 20a) are increased.

TABLE 6
Design of FIGS. 20a, 20b

| Turn | Flight Pitch | Channel Depth | # Channels | Channel Width |
|---|---|---|---|---|
| 0 | 18 | 4 | 1 | 15 |
| 3 | 18 | 4 | 1 | 15 |
| 11 | 18 | 1.5 | 1 | 15 |
| 12 | 20 | 1.3 | 1 | 16 |
| 13 | 22 | 1.4 | 2 | 8 |
| 14 | 22 | 1.5 | 2 | 8 |

With reference to TABLE 6, it is indicated that, from the 0^{th} turn up to (but not including) the 11^{th} turn of the channel 2020 of the extrusion screw 2000 (see FIGS. 20a, 20b), the channel depth is 4 mm, the channel width is 15 mm, and the flight pitch is 18 mm. At the 11^{th} turn of the channel 2020 (i.e., within the transition zone 2012), the channel depth is reduced from 4 mm to 1.5 mm, and at the 12^{th} turn of the channel 2020 (i.e., still within the transition zone 2012), the channel depth is further reduced from 1.5 mm to 1.3 mm. It is noted that the design of the extrusion screw 2000 is relatively aggressive with respect to compression and heating of the processed feedstock material in the transition zone 2012, thereby promoting the melting of the feedstock material within the transition zone 2012. It is further noted that high shear rates within the transition zone 2012 can be ameliorated by a lower compression ratio, due to an increase in the channel width from 15 mm at the 11th turn to 16 mm at the 12^{th} turn of the channel 2020 of the extrusion screw 2000.

At the 13^{th} turn (see FIGS. 20a and 20b) of the channel 2020 (i.e., at the start of the metering zone 2014), the channel 2020 is divided into the two (2) channels 2030, 2040, each having a channel width of 8 mm and a channel depth of 1.4 mm. The two (2) channels 2030, 2040 can operate to split or divide the processed feedstock material into narrower sections, so that any residual solids or agglomerates of the feedstock material are more likely to be adequately processed (e.g., melted) in the extrusion process. The two (2) channels 2030, 2040 can also operate to decompress the processed feedstock material, due to an increase in the cross-sectional areas of the respective channels 2030, 2040. By configuring the respective channels 2030, 2040 to decompress (and/or compress) the feedstock material being processed, the temperature and/or pressure of the processed feedstock material in the metering zone 2014 can be controlled. At the 14th turn (see FIGS. 20a and 20b) of the channel 2020 (i.e., within the metering zone 2014), each of the channels 2030, 2040 increases its channel depth from 1.4 mm to 1.5 mm, further decompressing the processed feedstock material.

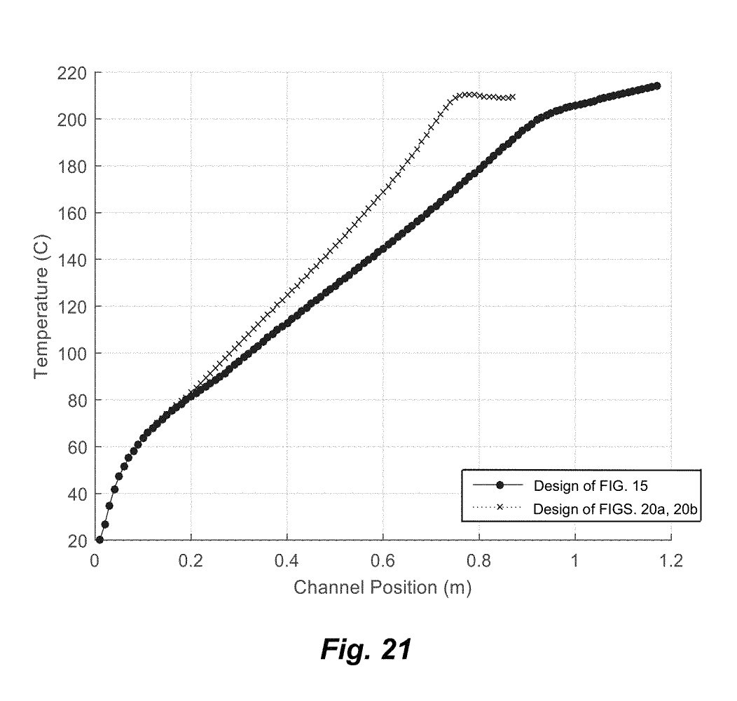

FIG. 21 depicts a graphical representation of exemplary estimates of the temperatures of processed feedstock material at locations along the length of the channel 1543 of the extrusion screw 1500 having the design of FIG. 15 (the “Design of FIG. 15”; see TABLE 5 and FIG. 21), as well as along the combined lengths of the channels 2020, 2030, 2040 of the extrusion screw 2000 having the design of FIGS. 20a and 20b (the “Design of FIGS. 20a, 20b; see TABLE 6 and FIG. 21). It is noted that the exemplary temperature estimates of FIG. 21 correspond to an extrusion process in which the feedstock material is processed at an extrusion screw speed of 360 RPM. It is further noted that the channel 1543 of the extrusion screw 1500 having the design of FIG. 15, as well as the respective channels 2020, 2030, 2040 of the extrusion screw 2000 having the design of FIGS. 20a and 20b, can each be configured to provide the exemplary temperature estimates of FIG. 21 by being modeled as a plurality of discrete sub-channels, in which each discrete sub-channel has a predetermined length of 10 mm or any other suitable channel length. With reference to FIG. 21, the channel 1543 of the extrusion screw 1500 having the design of FIG. 15 can have a total length of about 1.170 m (i.e., 1170 mm), whereas the channels 2020, 2030, 2040 of the extrusion screw 2000 can have a combined total length of about 0.870 m (i.e., 870 mm). By reducing the combined total length of the channels 2020, 2030, 2040 of the extrusion screw 2000, the overall length of the extrusion screw 2000 can be reduced relative to the overall length of the extrusion screw 1500.

The exemplary estimates of the temperatures of feedstock material being processed, as depicted in FIG. 21, show that the estimated temperatures of the processed feedstock material can increase more rapidly for the design of FIGS. 20a and 20b than for the design of FIG. 15. Moreover, for the design of FIGS. 20a and 20b, the estimated temperatures (i.e., the melt temperatures) can increase to a peak temperature of 210.5° C. at about the start of the metering zone 2014, and then decrease to 209.3° C. due to subsequent decompression of the processed feedstock material within the metering zone 2014.

In contrast, the extrusion screw 1500 having the design of FIG. 15 can have a length that is greater than that of the extrusion screw 2000, and can heat the feedstock material being processed at a slower rate than the extrusion screw 2000. Moreover, for the extrusion screw 1500 having the design of FIG. 15, the estimated temperatures (i.e., the melt temperatures) can increase to 202.6° C. at about the start of its metering zone 1547, and then further increase to 214.1° C. at the end of the metering zone 1547. Because the depth of each channel 2030, 2040 in the metering zone 2014 of the extrusion screw 2000 is increased to 1.4 mm, and then further increased to 1.5 mm toward the end of the metering zone 2014, the temperatures of the processed feedstock material can be controlled at least in part by decompressing the feedstock material at the end of the extrusion process. Unlike the channels 2030, 2040 of the extrusion screw 2000, the depth of the channel 1543 in the metering zone 1547 of the extrusion screw 1500 having the design of FIG. 15 remains constant, resulting in continued shear heating of the feedstock material for the remainder of the extrusion process. Such continued shear heating of the processed feedstock material can result in excessive temperatures that can degrade the feedstock material, and/or necessitate external cooling of the extruder barrel in the region of the metering zone 1547 of the extrusion screw 1500 having the design of FIG. 15.

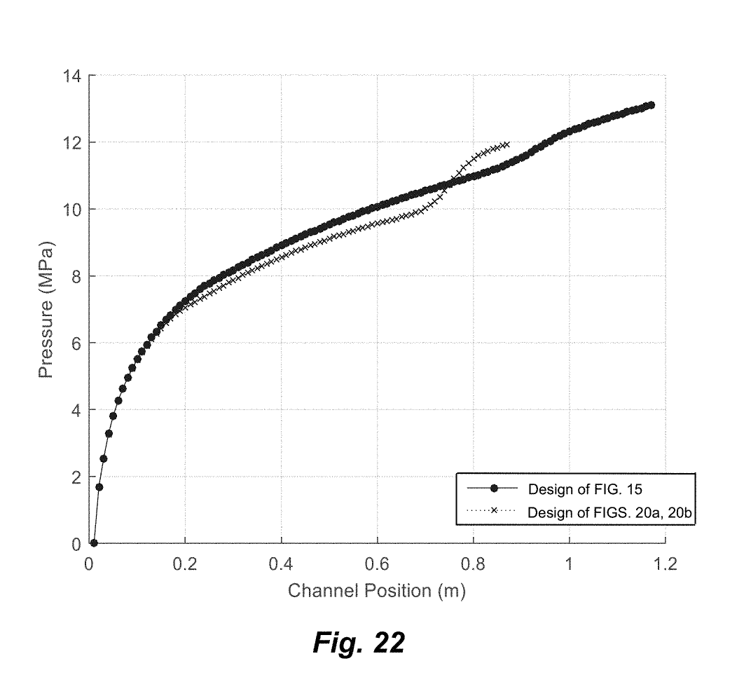

FIG. 22 depicts a graphical representation of exemplary estimates of the pressures of processed feedstock material at locations along the length of the channel 1543 of the extrusion screw 1500 having the design of FIG. 15 (the “Design of FIG. 15”; see TABLE 5 and FIG. 22), as well as along the combined lengths of the channels 2020, 2030, 2040 of the extrusion screw 2000 having the design of FIGS. 20a and 20b (the “Design of FIGS. 20a, 20b; see TABLE 6 and FIG. 22). It is noted that the exemplary pressure estimates of FIG. 22 correspond to an extrusion process in which the feedstock material is processed at an extrusion screw speed of 360 RPM. It is further noted that the channel 1543 of the design of FIG. 15, as well as the respective channels 2020, 2030, 2040 of the design of FIGS. 20a and 20b, can each be configured to provide the exemplary pressure estimates of FIG. 22 by being modeled as a plurality of discrete sub-channels, in which each discrete sub-channel has a predetermined length of 10 mm or any other suitable channel length.

The exemplary estimates of the pressures of processed feedstock material depicted in FIG. 22 show that the estimated pressures for the design of FIG. 15 and the estimated pressures for the design of FIGS. 20a and 20b can be similar in the feed zones of the extrusion screws having the respective designs. However, the estimated pressures for the design of FIGS. 20a and 20b can be reduced relative to the estimated pressures for the design of FIG. 15 through the transition zones of the respective designs (e.g., from about the channel position of 0.2 m to about the channel position of 0.750 m; see FIG. 22). Such a decrease in the estimated pressures for the extrusion screw 2000 having the design of FIGS. 20a and 20b can be due to increased shear rates and/or increased temperatures in the transition zone 2012, resulting in a lower viscosity of the feedstock material being processed by the extrusion screw 2000. However, the estimated pressures for the design of FIGS. 20a and 20b can be subsequently increased (relative to the estimated pressures for the design of FIG. 15) in the metering zone 2014 of the extrusion screw 2000 (e.g., from about the channel position of 0.750 m to about the channel position of 0.867 m; see FIG. 22). Such a subsequent increase in the estimated pressures for the extrusion screw 2000 having the design of FIGS. 20a and 20b can be due to the reduced depths of the respective channels 2020, 2030, 2040, which can cause higher shear rates, higher shear stresses, and greater pressure generation. As the depths of the channels 2030, 2040 of the extrusion screw 2000 gradually increase in the metering zone 2014, the processed feedstock material is decompressed, resulting in a decrease in the slope of the curve for the design of FIGS. 20a, 20b from about the channel position of 0.800 m to about the channel position of 0.867 m (see FIG. 22). In contrast, the extrusion screw 1500 having the design of FIG. 15 can provide an increased rate of pressure generation through its transition zone 1546, followed by a reduced rate of pressure generation in its metering zone 1547.

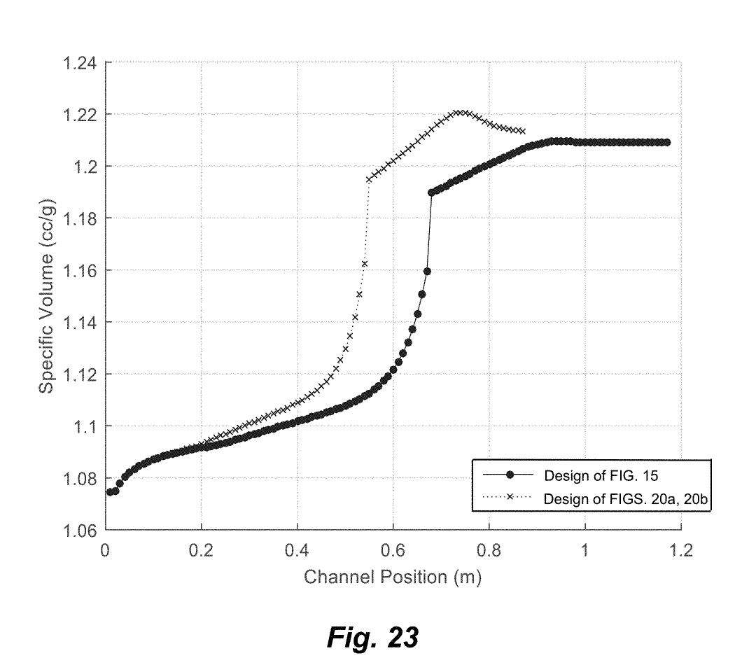

FIG. 23 depicts a graphical representation of exemplary estimates of specific volumes of processed feedstock material at locations along the length of the channel 1543 of the extrusion screw 1500 having the design of FIG. 15 (the “Design of FIG. 15”; see TABLE 5 and FIG. 23), as well as along the combined lengths of the channels 2020, 2030, 2040 of the extrusion screw 2000 having the design of FIGS. 20a and 20b (the “Design of FIGS. 20a, 20b; see TABLE 6 and FIG. 23). It is noted that the exemplary specific volume estimates of FIG. 23 correspond to an extrusion process in which the feedstock material is processed at an exemplary extrusion screw speed of 360 RPM. It is further noted that the channel 1543 of the design of FIG. 15, as well as the respective channels 2020, 2030, 2040 of the design of FIGS. 20a and 20b, can each be configured to provide the exemplary specific volume estimates of FIG. 23 by being modeled as a plurality of discrete sub-channels, in which each discrete sub-channel has a predetermined length of 10 mm or any other suitable channel length.

The exemplary estimates of specific volumes of processed feedstock material depicted in FIG. 23 show that the estimated specific volume for the design of FIGS. 20a and 20b can undergo a substantial increase at about the channel position of 0.480 m, whereas the estimated specific volume for the design of FIG. 15 can undergo a similar increase at about the channel position of 0.600 m. Such an increase in the estimated specific volume of the processed feedstock material can be associated with the conversion of the feedstock material from a semi-crystalline solid to an amorphous melt, in accordance with the estimated temperatures and pressures depicted in FIGS. 21 and 22, respectively. As shown in FIG. 23, for the extrusion screw 1500 having the design of FIG. 15, the estimated specific volume of the processed feedstock material can remain relatively constant along the length of its metering zone 1547 (e.g., about 1.2094 cc/g at the start of the metering zone 1547, and slightly decreasing to about 1.2091 cc/g at the end of the metering zone 1547). In contrast, for the extrusion screw 2000 having the design of FIGS. 20a and 20b, the estimated specific volume of the processed feedstock material can change substantially within the metering zone 2014, decreasing from about 1.2206 cc/g at the start of the metering zone 2014 to about 1.2133 cc/g at the end of the metering zone 2014, due to the geometries of the respective channels 2030, 2040 in the metering zone 2014 (as specified, for example, in TABLE 6).

The exemplary temperatures, pressures, and specific volumes of processed feedstock material depicted in FIGS. 21, 22, and 23, respectively, show that such temperatures, pressures, and/or specific volumes of the feedstock material can be controlled in an extrusion process by specifying the number and/or geometries (e.g., width, depth, pitch) of the channels of an extrusion screw in its feed zone, transition zone, and/or metering zone, in accordance with the target application and/or design objectives. It is noted that the temperature, pressure, and specific volume of a processed feedstock material can be a function of the properties of the feedstock material, as well as the conditions of the extrusion process.

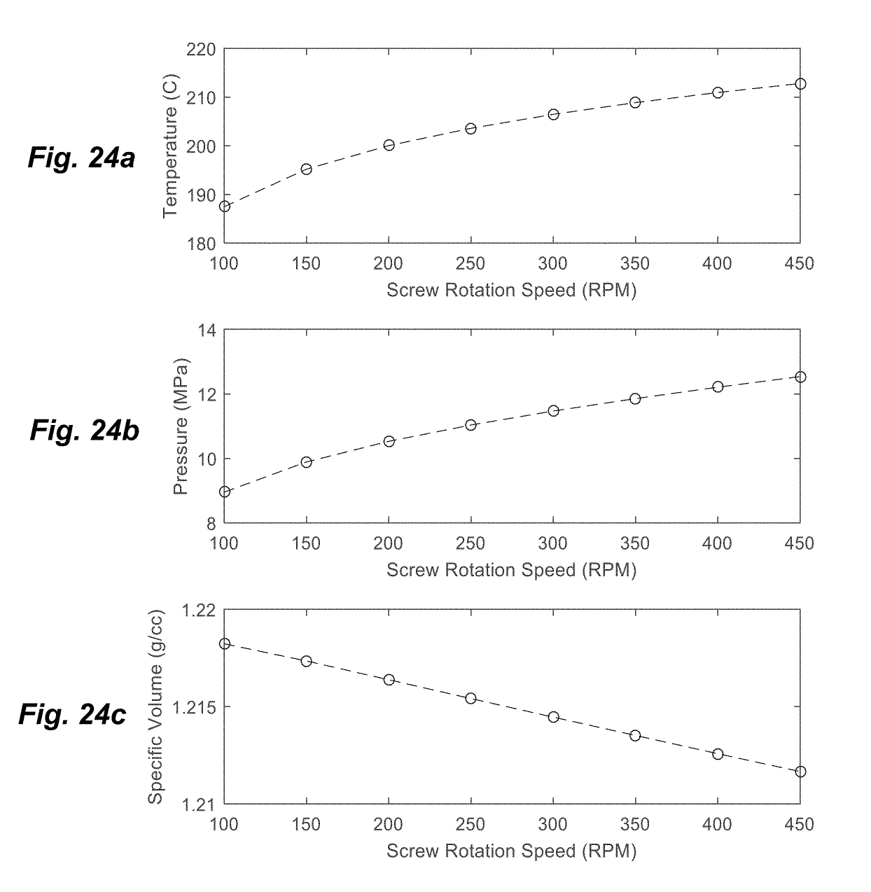

FIGS. 24a, 24b, and 24c depict graphical representations of exemplary estimates of temperatures, pressures, and specific volumes, respectively, of processed feedstock material as a function of the rotational speed (RPM) of an extrusion screw. It is noted that as the rotational speed of the extrusion screw increases, the shear rates of the feedstock material in the channel(s) of the extrusion screw can increase, resulting in increased internal viscous heating and higher temperatures of the feedstock material, as depicted in FIG. 24a. Such increased shear rates of the processed feedstock material can also cause increased pressures and/or shear stresses of the feedstock material, as depicted in FIG. 24b. However, as shown in FIG. 24c, the specific volume of the feedstock material being processed can decrease as the rotational speed of the extrusion screw increases, indicating that the increased pressures resulting from the increasing rotational speeds of the extrusion screw can have a greater effect on the compressibility of the feedstock material than any thermal expansion of the feedstock material that might result from increased temperatures.

The exemplary estimates of temperatures, pressures, and specific volumes of processed feedstock material depicted in FIGS. 24a, 24b, and 24c, respectively, show that such temperatures, pressures, and/or specific volumes of the feedstock material can be further controlled in an extrusion process by specifying the rotational speed of the extrusion screw, in accordance with the target application and/or design objectives. For example, such a target application and/or design objectives can call for the output temperature of the processed feedstock material to approximate the set-point temperature of an extrusion die or other downstream equipment used for forming the processed feedstock material at an output of an extruder.

It is noted that the design of FIGS. 20a and 20b, as well as the screw design parameters provided in TABLE 6, could be obtained by starting with the design of FIG. 15 and corresponding screw design parameters, such as the screw design parameters provided in TABLE 5. The channels of the extrusion screw design of FIG. 15 could then be modeled, and the geometries (e.g., channel width, channel depth, channel pitch) and/or the numbers of the channels could be simulated, analyzed, and/or optimized, using a predetermined computerized analytical or numerical technique, in order to obtain estimates of temperatures, pressures, specific volumes, etc., of feedstock material being processed by the respective channels (such as the estimated temperatures, pressures, and specific volumes of processed feedstock material depicted in FIGS. 21, 22, and 23, respectively). Based on such estimates of the temperatures, the pressures, the specific volumes, etc., of the processed feedstock material, the geometries and/or the numbers of the channels can be selected, in accordance with the target application and/or design objectives. For example, such design objectives can include the minimization of the overall length of the extrusion screw, the targeting of a specific output temperature for the extrudate, the maximization of the extrudate flow rate, the minimization of variations in the temperatures and/or the pressures of the processed feedstock material, etc.

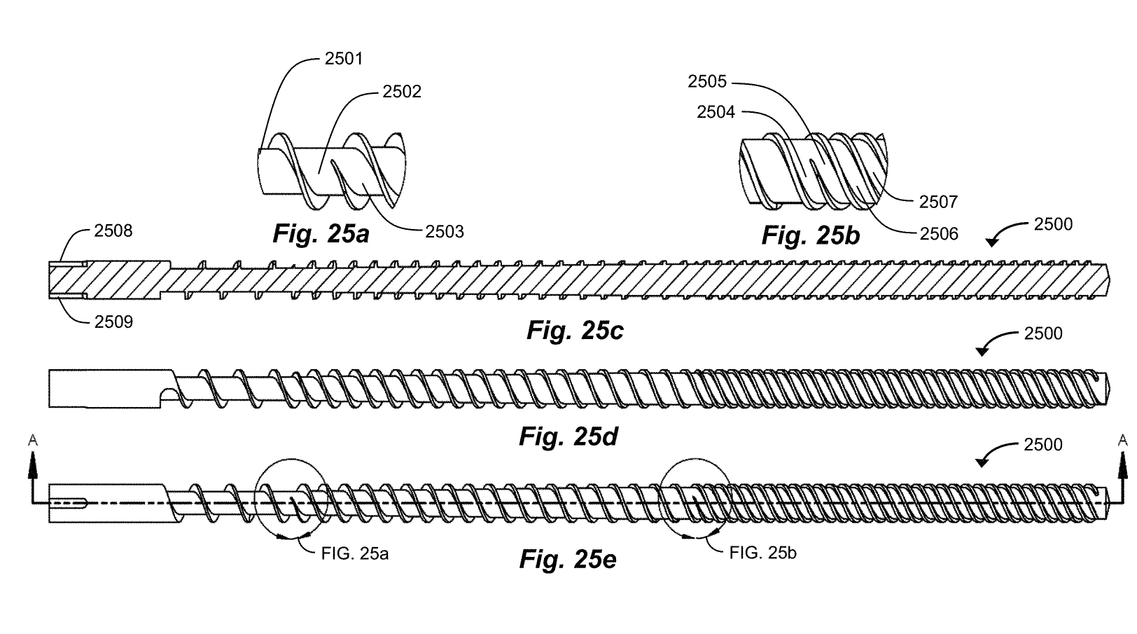

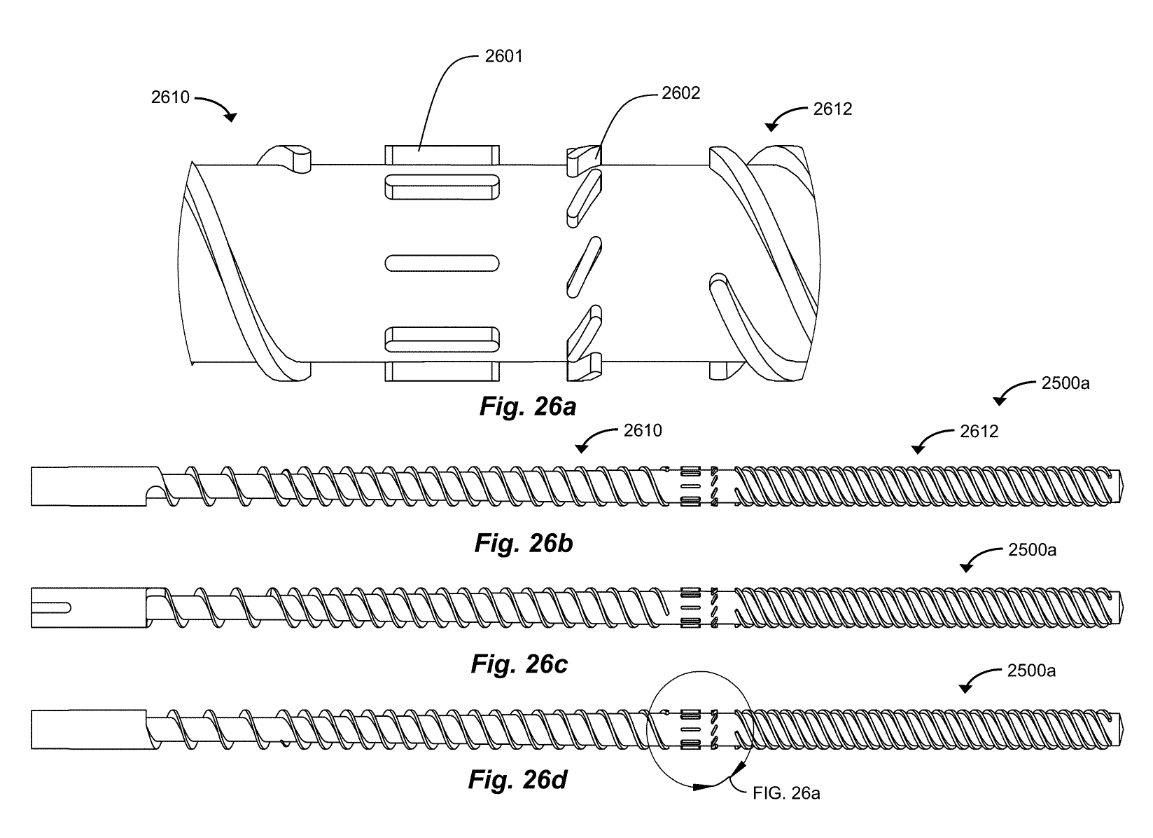

FIGS. 25d and 25e depict orthogonal views of an illustrative embodiment of an exemplary extrusion screw 2500. FIGS. 25a and 25b depict detail views of the extrusion screw 2500 of FIG. 25e. FIG. 25c depicts a cross-sectional view of the extrusion screw 2500 across a cross-section A-A (see FIG. 25). For example, the extrusion screw 2500 of FIGS. 25a-25e can have a diameter of 38.1 mm (or any other suitable diameter) and a length of 1028.7 mm (or any other suitable length). The extrusion screw 2500 can include a single feed channel 2501 (see FIG. 25a) having a channel width equal to 90% of the screw diameter (e.g., about 34.3 mm) and a channel depth equal to 20% of the screw diameter (e.g., about 7.6 mm) that transitions to two transition channels 2502, 2503 (see FIG. 25a) after three (3) rotations of the feed channel 2501. The transition channels 2502, 2503 can each have a channel width equal to 48.8% of the screw diameter (e.g., about 18.6 mm) and a channel depth at the end of a transition zone (e.g., a transition zone 2610; see FIG. 26b) equal to 8.0% of the screw diameter (e.g., about 3.0 mm) after ten (10) rotations of the transition channels 2502, 2503. The transition channel 2502 can feed two (2) metering channels 2504, 2505, and the transition channel 2503 can feed two (2) metering channels 2506, 2507. Each of the four (4) metering channels 2504, 2505, 2506, 2507 can have a channel width equal to 25.1% of the screw diameter (e.g., about 9.6 mm) and a channel depth at the end of a metering zone (e.g., a metering zone 2612; see FIG. 26b) equal to 9.0% of the screw diameter (e.g., about 3.4 mm) after nine (9) rotations of the metering channels 2504-2507. A proximal end of the extrusion screw 2500 can be provided with one or more keyways 2508, 2509 for fastening the extrusion screw 2500 to the rotating shaft of an extruder. The extrusion screw 2500 can provide a number of advantages, including, but not limited to, the capability of accepting a range of sizes of feedstock material, reduced residence time of processed feedstock material, narrower residence time distribution of the processed feedstock material, higher melt pressures, and more consistent homogeneity of the processed feedstock material.

FIGS. 26b-26d depict orthogonal views of an alternative embodiment (depicted in association with reference numeral 2500a) of the extrusion screw 2500 of FIGS. 25a-25e. FIG. 26a depicts a detail view of the extrusion screw 2500a of FIG. 26d. As shown in FIG. 26a, the extrusion screw 2500a can include an intermediate mixing section located between the transition zone 2610 and the metering zone 2612. The intermediate mixing section can include a first set of eight (8) mixing elements 2601 oriented in an axial direction of the extrusion screw 2500a. For example, each of the mixing elements 2601 can have a width equal to about 2.54 mm and a length equal to about 20.32 mm. The intermediate mixing section can further include a second set of twelve (12) smaller mixing elements 2602. For example, each of the mixing elements 2602 can have a width equal to about 2.54 mm and a curved shape with an arc length of about 10.16 mm. The mixing elements 2602 can be oriented approximately transverse to a helix angle of the metering channels in the metering zone 2612 in order to cause elongational flow and dispersive mixing of processed feedstock material. In this way, the processed feedstock material can be further homogenized prior to final metering of the feedstock material in the metering zone 2612. It is noted that the metering channels in the metering zone 2612 of the extrusion screw 2500a can have the same channel length, the same channel width, and the same channel depth so as to provide uniform flow, pressure, and temperature of the processed feedstock material. It is further noted that the first and second sets of mixing elements 2601, 2602 are described herein for purposes of illustration, and that any other suitable mixing elements in the intermediate mixing section of the extrusion screw 2500a can be employed.

While the foregoing extrusion apparatus and methods have been described herein in conjunction with various illustrative embodiments and examples, it is not intended that the present teachings be limited to such illustrative embodiments or examples. It is also be noted that various parameters, dimensions, materials, and configurations described herein are meant to be illustrative, and that the actual parameters, dimensions, materials, and/or configurations can depend upon the specific target application or applications for which the present teachings is/are used.

It is further noted that the operations described herein are purely exemplary and imply no particular order. Further, the operations can be used in any sequence when appropriate and can be partially used. With the above illustrative embodiments in mind, it should be understood that the analytical and/or numerical techniques described herein for modeling, simulating, analyzing, and/or optimizing an extrusion screw could employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and/or otherwise manipulated.

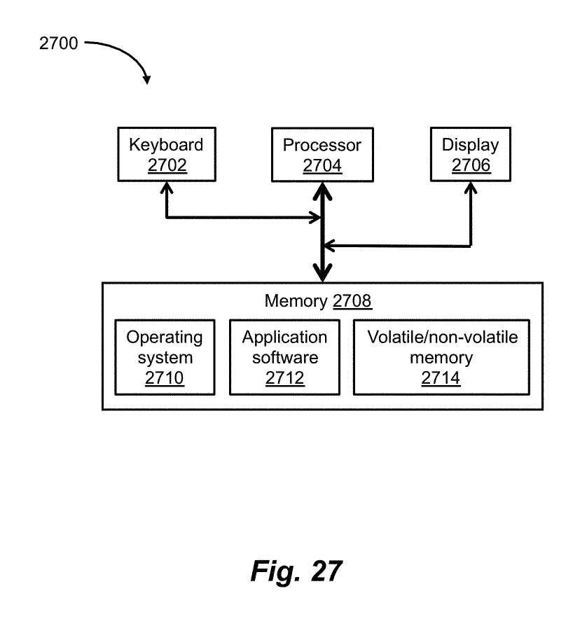

It should further be understood that any of the operations described herein are useful machine operations. The analytical and/or numerical techniques described herein also relate to a device or an apparatus for performing such operations. Such an apparatus can be specially constructed for the required purpose, or the apparatus can be a general-purpose computer selectively activated or configured by a software program stored in the computer. For example, various general-purpose machines employing one or more processors coupled to one or more computer readable media can be used with software programs written in accordance with the teachings herein. FIG. 27 depicts an illustrative embodiment of such a general-purpose machine 2700, which can include a keyboard 2702, a processor 2704, a display 2706, and a memory 2708, which, in turn, can include volatile or non-volatile memory 2714, as well as store an operating system 2710 and application software 2712. Alternatively, it may be more convenient to construct a more specialized apparatus to perform the required operations.

It will be appreciated by those of ordinary skill in the art that modifications to and variations of the above-described extrusion apparatus and methods may be made without departing from the inventive concepts disclosed herein. Accordingly, the present application should not be viewed as limited except as by the scope and spirit of the appended claims.

1. A screw for use in a manufacturing process, comprising:
a cylindrical body; and
one or more helical channels formed in a surface of the cylindrical body, each of the one or more helical channels having at least a channel width and a channel depth,
wherein the one or more helical channels are configured to receive a feedstock material, and, in response to rotation of the cylindrical body, to control one or more of a temperature, a pressure, and a shear rate of the feedstock material flowing through the respective helical channels based at least on the channel width or the channel depth of the respective helical channels.

2. The screw of claim 1 wherein each of the one or more helical channels is so configured to control one or more of the temperature, the pressure, and the shear rate of the feedstock material by being modeled as a model object with a predetermined geometry, the predetermined geometry having one or more dimensions representing one or more of the channel width and the channel depth of the helical channel, the model object being analyzed to obtain at least an estimate of the temperature, the pressure, or the shear rate of the feedstock material based at least on the one or more dimensions of the predetermined geometry of the model object.

3. The screw of claim 2 wherein the model object is further analyzed to obtain at least the estimate of the temperature, the pressure, or the shear rate of the feedstock material as a function of one or more of a temperature level of the screw, a rotational speed of the screw, a volumetric flow rate of the feedstock material, and a shear heating level of the feedstock material, based at least on one or more of a compressibility behavior and a viscosity behavior of the feedstock material.

4. The screw of claim 2 wherein the model object is configured to represent at least one discrete section of the helical channel.

5. The screw of claim 4 wherein the predetermined geometry of the model object is a prismatic geometry.

6. The screw of claim 5 wherein the prismatic geometry is configured as a rectangular cuboid.

7. The screw of claim 2 wherein the cylindrical body has at least a first zone disposed toward a proximal end of the cylindrical body, and a second zone disposed toward a distal end of the cylindrical body, and wherein the one or more helical channels include one or more first helical channels within the first zone, and one or more second helical channels within the second zone.

8. The screw of claim 7 wherein each of the one or more first helical channels has at least a first channel width and a first channel depth, and is configured to control one or more of the temperature, the pressure, and the shear rate for compressing the feedstock material flowing through the first helical channel.

9. The screw of claim 8 wherein the model object is further analyzed to obtain at least the estimate of the temperature, the pressure, or the shear rate of the feedstock material based on the one or more dimensions of the predetermined geometry representing a decrease in one or more of the first channel width and the first channel depth of the first helical channel.

10. The screw of claim 7 wherein each of the one or more second helical channels has at least a second channel width and a second channel depth, and is configured to control one or more of the temperature, the pressure, and the shear rate for decompressing the feedstock material flowing through the second helical channel.

11. The screw of claim 10 wherein the model object is further analyzed to obtain at least the estimate of the temperature, the pressure, or the shear rate of the feedstock material based on the one or more dimensions of the predetermined geometry representing an increase in one or more of the second channel width and the second channel depth of the second helical channel.

12. The screw of claim 1 wherein the cylindrical body has at least a first zone disposed toward a proximal end of the cylindrical body, a third zone disposed toward a distal end of the cylindrical body, and a second zone disposed between the first zone and the third zone, wherein the one or more helical channels includes one or more first helical channels within the first zone, one or more second helical channels within the second zone, and two or more third helical channels within the third zone.

13. The screw of claim 12 wherein at least one of the respective second helical channels within the second zone is configured to be divided to form the two or more third helical channels within the third zone.

14. The screw of claim 12 further comprising:
an outlet formed in the surface of the cylindrical body at the distal end,
wherein at least two of the respective third helical channels within the third zone is configured to be merged to form a single helical channel at the outlet of the screw.

15. The screw of claim 12 wherein the screw is an extrusion screw, wherein the first zone corresponds to a feed zone of the extrusion screw, wherein the second zone corresponds to a transition zone of the extrusion screw, and wherein the third zone correspond to a metering zone of the extrusion screw.

16. The screw of claim 15 further comprising:
a mixing section disposed between the transition zone and the metering zone of the extrusion screw.

17. A method of designing a screw for use in a manufacturing process, the screw including a cylindrical body, and one or more helical channels formed in a surface of the cylindrical body, the one or more helical channels being configured to receive a feedstock material, the method comprising:
modeling each of the one or more helical channels of the screw as a model object with a predetermined geometry, the predetermined geometry having one or more dimensions representing one or more of a channel width and a channel depth of the helical channel;
computer-analyzing the model object to obtain at least an estimate of a temperature, a pressure, or a shear rate of the feedstock material flowing through the respective helical channels based at least on the one or more dimensions of the predetermined geometry of the model object; and
producing a physical version of the screw having the one or more helical channels that conform with the respective dimensions of the predetermined geometry of the model object.

18. The method of claim 17 wherein the modeling of the respective helical channels of the screw includes forming the model object of each helical channel as a helically swept cut in a cylindrical solid representing the cylindrical body of the screw.

19. The method of claim 18 wherein the forming of the model object of each helical channel includes forming the helically swept cut by sweeping a predetermined channel cross-section along a variable pitch helix about the cylindrical solid.

20. The method of claim 19 wherein the forming of the helically swept cut includes specifying the variable pitch helix for merging two or more downstream helical channels into a single upstream helical channel.

21. The method of claim 19 wherein the forming of the helically swept cut includes specifying the variable pitch helix for dividing one or more upstream helical channels into multiple downstream helical channels.

22. The method of claim 18 wherein the modeling of the respective helical channels of the screw includes forming one or more flights of the respective helical channels by adding one or more protrusions to the cylindrical body.

23-25. (canceled)

26. A method of operating a screw in a manufacturing process, comprising:
providing the screw having a cylindrical body, and one or more helical channels formed in a surface of the cylindrical body, each of the one or more helical channels having at least a channel width and a channel depth;
receiving a feedstock material at one or more inlets of the helical channels; and
in response to rotation of the screw, controlling one or more of a temperature, a pressure, and a shear rate of the feedstock material flowing through the respective helical channels based at least on one or more of the channel width and the channel depth of the respective helical channels.

27-32. (canceled)
